(19) United States
(12) Patent Application Publication
(10) Pub. No.: US 2025/0305338 A1
(43) Pub. Date: Oct. 2, 2025

(54) DOOR DEVICE FOR VEHICLE

(71) Applicants: AISIN CORPORATION, Kariya (JP); TOYOTA JIDOSHA KABUSHIKI KAISHA, Toyota-shi (JP)

(72) Inventors: Katsusuke ARAKI, Kariya-shi (JP); Tatsuya SASO, Kariya-shi (JP); Yosuke TSUGE, Kariya-shi (JP); Naoki GOTOH, Kariya-shi (JP); Hideaki KANASUGI, Miyoshi-shi (JP); Tomohiro KOJIMA, Nisshin-shi (JP)

(73) Assignees: AISIN CORPORATION, Kariya (JP); TOYOTA JIDOSHA KABUSHIKI KAISHA, Toyota-shi (JP)

(21) Appl. No.: 19/081,358

(22) Filed: Mar. 17, 2025

(30) Foreign Application Priority Data
Mar. 28, 2024 (JP) 2024-054627

(51) Int. Cl. E05D 15/10; E05D 11/10

(52) U.S. Cl. CPC E05D 15/101; E05D 11/1042; E05Y 2201/224; E05Y 2201/624; E05Y 2201/638; E05Y 2900/531

(57) ABSTRACT

PROBLEM: To stably support a door.

SOLUTION: A door device includes: an engagement member provided in a variable link equipped with a variable connection length mechanism; and a cam member provided on a door and having a cam groove with which the engagement member engages. Furthermore, an extension end of the cam groove that comes into close proximity to an engagement part of the engagement member that moves within the cam groove, based on full opening movement of the door is an opening side end of the cam groove. The cam groove has a groove width change section being set on an opening side of the extension region including the opening side end, and a groove width of the cam groove in this groove width change section is narrower than a groove width on a closing side of the extension region beyond the groove width change section.

### CROSS REFERENCE TO RELATED APPLICATIONS

This application is based on and claims priority under 35 U.S.C. § 119 to Japanese Patent Application 2024-054627, filed on Mar. 28, 2024, the entire content of which is incorporated herein by reference.

### TECHNICAL FIELD

This disclosure generally relates to a door device for vehicle.

### BACKGROUND DISCUSSION

Conventionally, there is provided a door device for vehicle including a first link arm and a second link arm each of which has a first rotational connection point with respect to a vehicle body and a second rotational connection point with respect to a door of a vehicle. In such a door device for vehicle, the door provided in a door opening opens and closes, based on movement of a link mechanism constituted of the first and second link arms. Furthermore, for example, JP2023-68618A describes a configuration in which one of the link arms is defined as a variable link and is equipped with a variable connection length mechanism that allows a connection length between the first and second rotational connection points to be changed. By adopting such a configuration, a degree of freedom in the opening and closing movement of the door that opens and closes, based on the movement of the link mechanism, can be increased.

A need thus exists for a door device for vehicle, which is not susceptible to the drawback mentioned above.

### SUMMARY

A door device for vehicle according to the present disclosure includes a first link arm and a second link arm each having a first rotational connection point with respect to a vehicle body and a second rotational connection point with respect to a vehicle door, the door opens and closes, based on movement of a link mechanism constituted of the first link arm and second link arm, at least one of the first link arm and the second link arm is a variable link with a variable connection length mechanism that allows a connection length between the first rotational connection point and the second rotational connection point to be changed, the door device for vehicle includes: an engagement member being provided in the variable link; and a cam member being provided on the door and having a cam groove with which the engagement member engages, an extension end of the cam groove that comes into close proximity to an engagement part of the engagement member that moves within the cam groove, based on full opening movement of the door, is an opening side end of the cam groove, the cam groove has a groove width change section being set on an opening side of an extension region including the opening side end, and a groove width of the cam groove in the groove width change section is narrower than a groove width of the cam groove on a closing side of the extension region than the groove width change section.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a door device;

FIG. 2 is a perspective view of the door device;

FIG. 3 is a plan view of first and second link arms that constitute a link mechanism;

FIG. 4 is a plan view of the first and second link arms that constitute the link mechanism;

FIG. 5 is a plan view of the first and second link arms that constitute the link mechanism;

FIG. 6 is a plan view of the first and second link arms that constitute the link mechanism;

FIG. 7 is a schematic configuration diagram of a door side engagement part and a vehicle body side engagement part;

FIG. 8 is a perspective view of the door side engagement part and the vehicle body side engagement part, as well as, a door and a door opening;

FIG. 9 is a system configuration diagram of the door device;

FIG. 10 is a perspective view of an area near the door opening where the door device is installed;

FIG. 11 is a plan view of an articulated link;

FIG. 12 is a plan view of the articulated link;

FIG. 13 is a plan view of a variable link using the articulated link;

FIG. 14 is an explanatory diagram of movement of the variable link using the articulated link;

FIG. 15 is an exploded perspective view of the variable link using the articulated link;

FIG. 16 is a side view of a vehicle body side link and a vehicle body bracket that constitute the articulated link;

FIG. 17 is a cross-sectional view of the vehicle body side link and the vehicle body bracket;

FIG. 18 is a side view of a door bracket and the articulated link;

FIG. 19 is a side view of the door bracket and the articulated link;

FIG. 20 is a side view of the door bracket and the articulated link;

FIG. 21 is a plan view of the articulated link connected to the door via the door bracket;

FIG. 22 is a plan view of the articulated link connected to the door via the door bracket;

FIG. 23 is a plan view of the articulated link connected to the door via the door bracket;

FIG. 24 is a partial cross-sectional view of the door bracket illustrating a cam groove of a cam member with which the engagement member provided in the variable link engages;

FIG. 25 is a perspective view of an area near a door stopper provided on the door bracket on a side of the second link arm;

FIG. 26 is a plan view of an area near the door stopper provided on the door bracket on a side of the first link arm;

FIG. 27: is a perspective view of the area near the door stopper provided on the door bracket on the side of the first link arm;

FIG. 28 is a perspective view of an area near a door side mating part that constitutes a down stopper; and

FIG. 29 is a perspective view of an area near the vehicle body side mating part that constitutes the down stopper.

### DETAILED DESCRIPTION

An embodiment of the door device for vehicle is described below with reference to the drawings.

### <Link Mechanism>

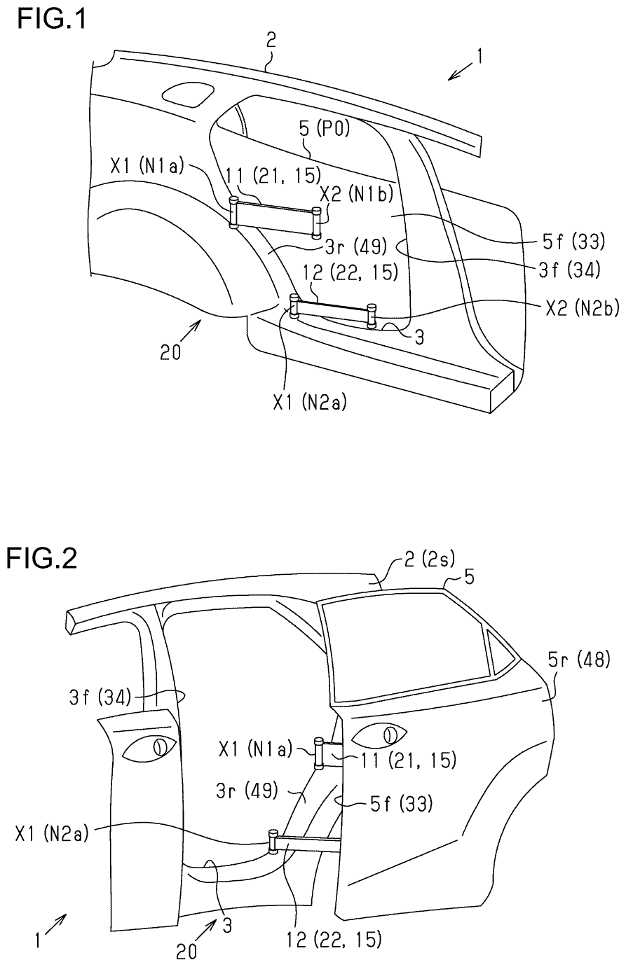

As Illustrated in FIGS. 1 and 2, a Vehicle 1 of the Present Embodiment Includes a Door Opening 3 Provided on a Side Surface 2s of a Vehicle Body 2. The Door Opening 3 is Provided with a First Link Arm 11 and a Second Link Arm 12 that Support a Door 5 of the Vehicle 1 in the Door Opening 3.

In detail, in the vehicle 1 of the present embodiment, these first and second link arms 11, 12 each have a first rotational connection point X1 with respect to the vehicle body 2 and a second rotational connection point X2 with respect to the door 5. Specifically, the first link arm 11 is connected to the vehicle body 2 in a state where the first link arm 11 is supported by a support shaft N1a extending in an up-down direction (the up-down direction in each drawing), and is connected to the door 5 in a state where the first link arm 11 is supported by a support shaft N1b extending in the up-down direction. The second link arm 12 is also connected to the vehicle body 2 in a state where the second link arm 12 is supported by a support shaft N2a extending in the up-down direction, and is connected to the door 5 in a state where the second link arm 12 is supported by a support shaft N2b extending in the up-down direction.

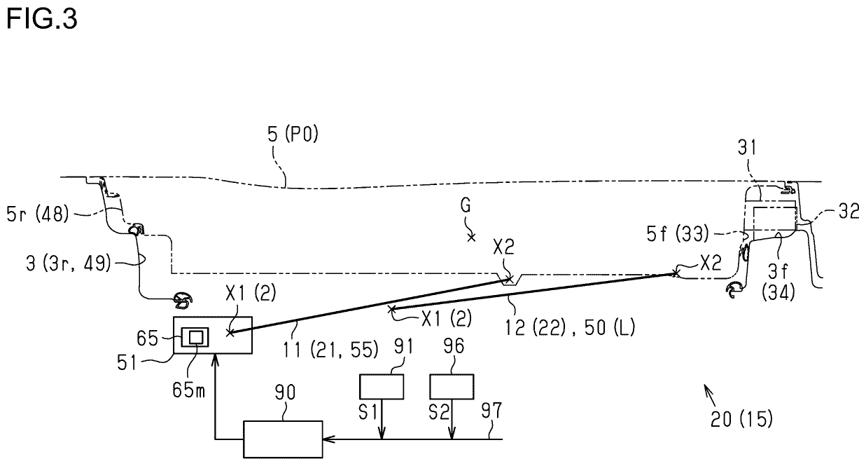

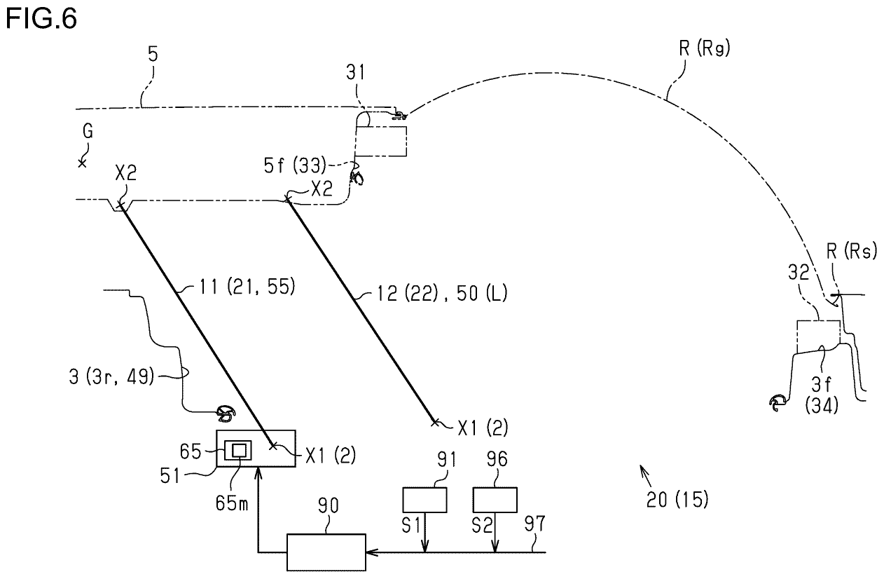

That is, as illustrated in FIGS. 3 to 6, in the vehicle 1 of the present embodiment, these first and second link arms 11, 12 form a link mechanism 15 configured as a four-node link. The vehicle 1 of the present embodiment is thus configured to open and close the door 5 supported by the door opening 3 according to the movement of this link mechanism 15.

In further detail, as illustrated in FIGS. 1 and 2, the vehicle 1 of the present embodiment uses these first and second link arms 11, 12 to support its door 5 in the door opening 3 on the rear side of the vehicle (the left side in FIG. 1 and the right side in FIG. 2). In the vehicle 1 of the present embodiment, these first and second link arms 11, 12 each have a first rotational connection point X1 that is rotatably connected to the vehicle body 2 near the rear edge 3r of the door opening 3. In the vehicle 1 of the present embodiment, these first and second link arms 11, 12 are spaced apart in the up-down direction.

In the vehicle 1 of the present embodiment, the first link arm 11 is provided higher than the second link arm 12. The first link arm 11 has a second rotational connection point X2 that is rotatably connected to this door 5 at an approximate center position in the front-back direction of the door 5. On the other hand, the second link arm 12 has a second rotational connection point X2 that is connected to this door 5 near the front end 5f of the door 5. In the vehicle 1 of the present embodiment, this forms a door device 20 such that the door 5 opens and closes according to the movement of the link mechanism 15 formed by the first and second link arms 11, 12.

### <Movement of Link Mechanism>

Specifically, as illustrated in FIGS. 3 to 6, in the door device 20 of the present embodiment, when the door 5 opens, the first and second link arms 11, 12 rotate in a counterclockwise direction in each drawing around the respective first rotational connection points X1. This causes the door 5 of the vehicle 1 supported by these first and second link arms 11, 12 to open to the rear side of the vehicle (the left side in each drawing).

In the door device 20 of the present embodiment, when the door 5 closes, the first and second link arms 11, 12 rotate in a clockwise direction in each drawing around the respective first rotational connection points X1. This causes the door 5 of the vehicle 1 supported by these first and second link arms 11, 12 to close to the front side of the vehicle (the right side in each drawing).

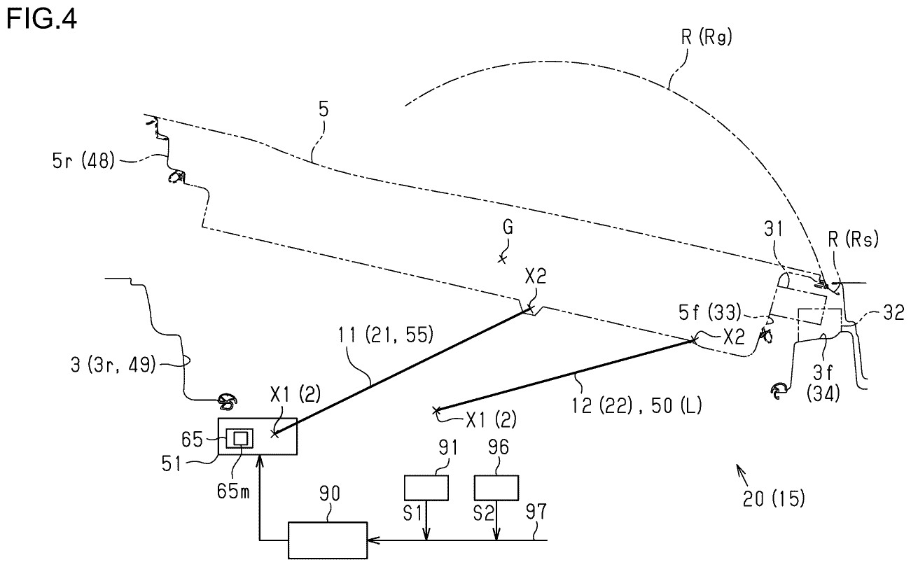

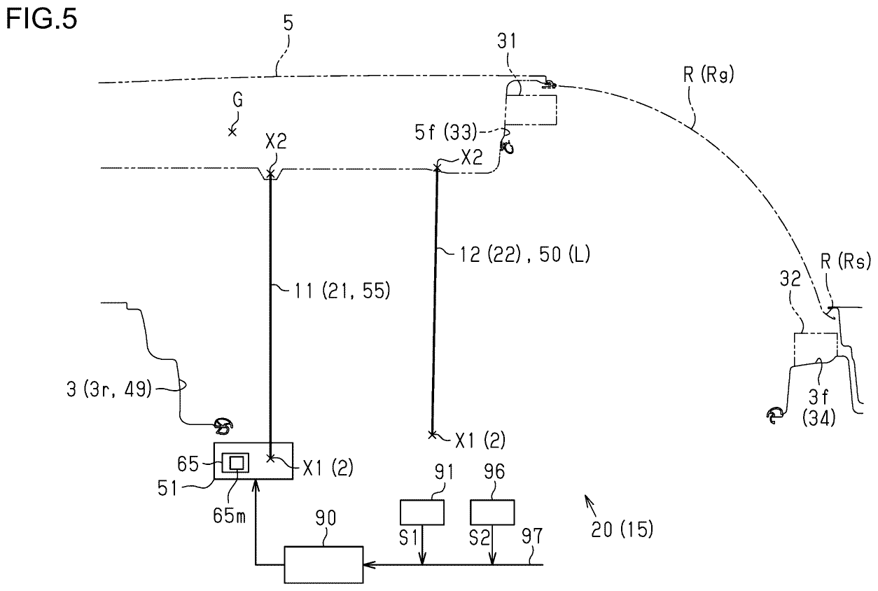

Furthermore, the door device 20 of the present embodiment has opening and closing movement trajectory R of the door 5 defined so as to draw an arcuate glide trajectory Rg based on the movement of the link mechanism 15 formed by the first and second link arms 11, 12. That is, as illustrated in FIG. 5, at an intermediate position where the first and second link arms 11, 12 extend in the vehicle width direction (the up-down direction in FIGS. 3 to 6), the movement component in the front-back direction of the vehicle becomes larger. Then, as illustrated in FIGS. 3 and 4, as the opening and closing movement position of the door 5 becomes closer to the fully closed position P0, the first and second link arms 11, 12 extend in the front-back direction of the vehicle (the left-right direction in FIGS. 3 to 6), and the movement component in the vehicle width direction becomes larger.

In the door device 20 of the present embodiment, the first link arm 11 has its second rotational connection point X2 with respect to the door 5 at a position closer to the center of gravity G than the second link arm 12 does. That is, in the door device 20 of the present embodiment, this first link arm 11 is thereby positioned as a main link 21 that supports a larger door load. Then, the second link arm 12 is positioned as a sub link 22 that has a relatively smaller door load acting on it.

In the door device 20 of the present embodiment, the first link arm 11 has a larger external shape than the second link arm 12. The door device 20 of the present embodiment is thus configured to provide higher support rigidity to the first link arm 11 positioned as the main link 21.

### <Door Side Engagement Part and Vehicle Body Side Engagement Part>

As illustrated in FIGS. 3 to 7, the door device 20 of the present embodiment includes a door side engagement part 31 provided on the front end 5f of the door 5 and a vehicle body side engagement part 32 provided on the front edge 3f of the door opening 3. That is, in the vehicle 1 of the present embodiment, the door side engagement part 31 is provided at the closing side end 33 located on the closing movement side of the door 5 that opens and closes the door opening 3 of the vehicle 1 according to the movement of the link mechanism 15 formed by the first and second link arms 11, 12. Furthermore, the vehicle body side engagement part 32 is provided at the closing side end 34 of the door opening 3 where the closing side end 33 of the door 5 contacts or separates from, that is, approaches or moves away from, the closing side end 34 of the door opening 3 according to the opening and closing movement of the door 5 that moves in the front-back direction of the vehicle. The door device 20 of the present embodiment is configured such that the door side engagement part 31 and the vehicle body side engagement part 32 engage with each other in a state where the door 5 is near the fully closed position P0.

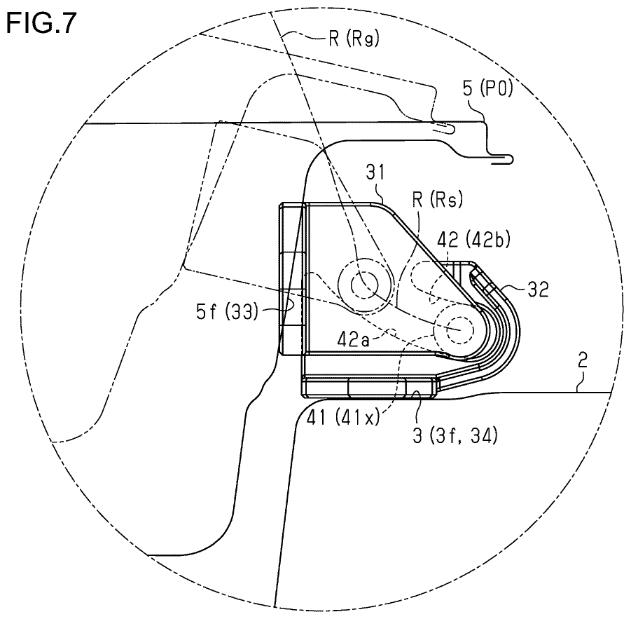

In detail, the door side engagement part 31 of the present embodiment includes, as its guide engagement part, an axial engagement part 41 extending in the up-down direction of the vehicle 1 (in a direction perpendicular to the paper surface in FIG. 7). In the door device 20 of the present embodiment, the axial engagement part 41 as the guide engagement part has a configuration as a roller 41x rotatably supported around a support shaft, not illustrated, extending in the up-down direction. Furthermore, the vehicle body side engagement part 32 includes a guide groove 42 extending in the opening and closing movement direction of the door 5 with a pair of side wall sections 42a, 42b facing each other in the vehicle width direction (the up-down direction in FIG. 7). The door device 20 of the present embodiment is configured such that when the door 5 is near the fully closed position P0, the door side engagement part 31 and the vehicle body side engagement part 32 engage with each other in a state where the axial engagement part 41 that constitutes the guide engagement part is placed within this guide groove 42.

That is, the displacement of the door 5 in the vehicle width direction is regulated by the placement of the axial engagement part 41 of the door side engagement part 31 within the guide groove 42 of the vehicle body side engagement part 32 in a state where the axial engagement part 41 is sandwiched between a pair of side wall sections 42a, 42b opposing each other in the vehicle width direction. The door device 20 of the present embodiment is thus able to stably support the door 5 even near the fully closed position P0 where the first and second link arms 11, 12 forming the link mechanism 15 tend to become aligned.

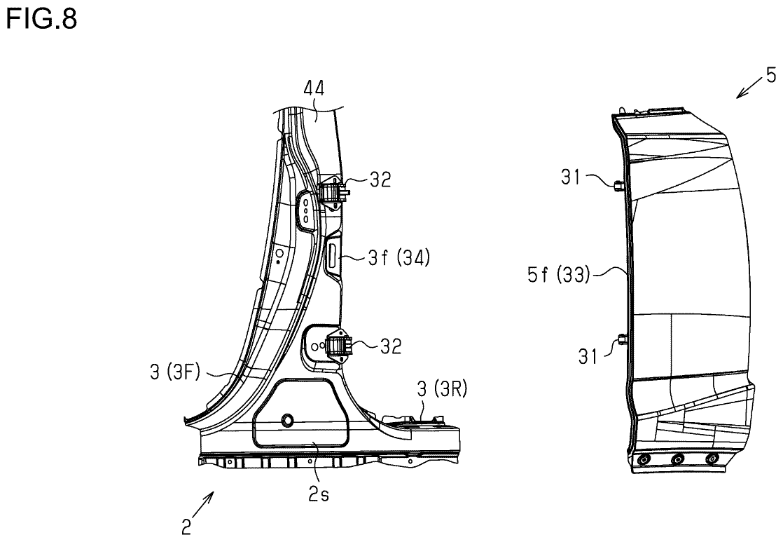

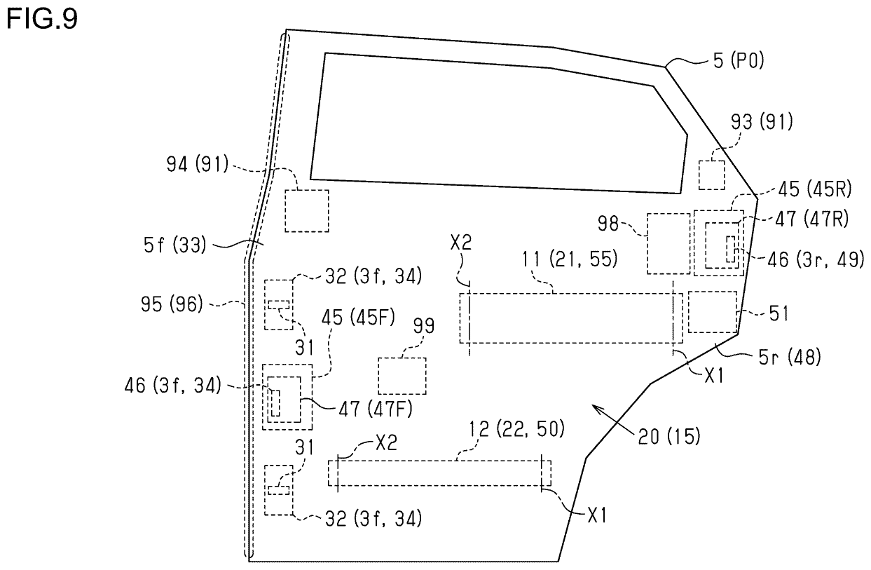

In further detail, as illustrated in FIGS. 8 and 9, the door device 20 of the present embodiment includes door side engagement parts 31, 31 provided on the front end 5f of the door 5 at two positions spaced apart in the up-down direction. Furthermore, the door device 20 includes vehicle body side engagement parts 32, 32 provided on the front edge 3f of the door opening 3 at two positions also spaced apart in the up-down direction. The door device 20 of the present embodiment is configured to hold the door 5 at the fully closed position P0 in a state where these door side engagement parts 31, 31 and vehicle body side engagement parts 32, 32 are engaged with each other.

Specifically, the door 5 supported by this link mechanism 15 is configured as a rear door. Furthermore, in the vehicle 1 of the present embodiment, the B-pillar 44 divides the door opening 3F at the front of the vehicle from the door opening 3R at the rear of the vehicle. In the door device 20 of the present embodiment, the vehicle body side engagement parts 32, 32 are provided on the B-pillar 44.

### <Lock Device>

As illustrated in FIG. 9, the door device 20 of the present embodiment is equipped with a lock device 45 that holds the door 5 in a fully closed state. Specifically, this door device 20 includes a rear lock 45R provided at the rear end 5r of the door 5 and a front lock 45F provided at the front end 5f of the door 5 as the lock device 45. Furthermore, each of the lock device 45 includes a latch mechanism 47 that engages with a striker 46 provided on the vehicle body 2 side when the door 5 moves to the fully closed position P0. Each lock device 45 restrains the door 5 at the fully closed position P0 based on the engagement force of the latch mechanism 47 and the striker 46.

That is, the front latch 47F that constitutes the latch mechanism 47 of the front lock 45F restrains the front end 5f of the door 5 on which this front latch 47F is provided, that is, the closing side end 33 of the door 5, to the front edge 3f of the door opening 3 that is the closing side end 34 of the door opening 3. In the vehicle 1 of the present embodiment, the striker 46 to engage with the front latch 47F is also provided on the B pillar 44. Furthermore, the rear latch 47R that constitutes the latch mechanism 47 of the rear lock 45R restrains the rear end 5r of the door 5 on which this rear latch 47R is provided, that is, the opening side end 48 of the door 5, to the rear edge 3r of the door opening 3 that is the opening side end 49 of the door opening 3. The door device 20 of the present embodiment is thus configured to stably hold the door 5 that has moved to the fully closed position P0 in the fully closed state.

### <Variable Connection Length Mechanism>

As illustrated in FIGS. 3 to 6, in the door device 20 of the present embodiment, the second link arm 12, positioned as the sub link 22, is provided with a variable connection length mechanism 50 that allows the connection length L between the first and second rotational connection points X1, X2 to be changed. Furthermore, this variable connection length mechanism 50 is energized in a direction of shortening the length between the first and second rotational connection points X1, X2, that is, the connection length L of the door 5, formed by the second link arm 12 provided with this variable connection length mechanism 50. The door device 20 of the present embodiment is thus configured to open and close the door 5 in a state where the connection length L formed by the second link arm 12 is shortened.

As illustrated in FIGS. 3, 4, and 7, in the door device 20 of the present embodiment, the door 5 is allowed to open and close in a state where the door side engagement part 31 and the vehicle body side engagement part 32 are engaged with each other according to the movement of the variable connection length mechanism 50 provided in the second link arm 12. Specifically, as the door 5 opens and closes in a state where the door side engagement part 31 and the vehicle body side engagement part 32 are engaged with each other, the axial engagement part 41 is displaced relatively along the extension direction of the guide groove 42 while changing the connection length L according to the movement of the variable connection length mechanism 50. In the door device 20 of the present embodiment, the opening and closing movement trajectory R of the door 5 changes accordingly.

In other words, in the door device 20 of the present embodiment, when the door 5 moves to the fully closed position P0, the opening and closing movement of the door 5 is guided in a state where the axial engagement part 41 is placed within the guide groove 42 by engaging the door side engagement part 31 with the vehicle body side engagement part 32. The door device 20 of the present embodiment is thus configured such that a glide trajectory Rg based on the movement of the link mechanism 15 changes to a linear slide trajectory Rs along the opening width direction of the door opening 3.

In the case of the door opening 3 provided on the side surface 2s of the vehicle body 2, as in the vehicle 1 of the present embodiment, the ‘opening width direction’ is the front-back direction of the vehicle. In this case, the ‘opening direction’ of the door opening 3 that communicates the interior and exterior of the vehicle, not illustrated, is the vehicle width direction.

Specifically, in the door device 20 of the present embodiment, when the door 5 closes fully, an operating force in the closing movement direction is applied to the door 5 in a state where the door side engagement part 31 and the vehicle body side engagement part 32 are engaged with each other. In the door device 20 of the present embodiment, the operating force to open and close the door 5 is assumed to be caused by the driving force of the drive device described below or manual operation by a user. Furthermore, in this case, the variable connection length mechanism 50 provided in the second link arm 12 moves according to the operating force in the closing movement direction, thereby extending the connection length L of the door 5, formed by the second link arm 12, according to the engagement state between the door side engagement part 31 and the vehicle body side engagement part 32. The door device 20 of the present embodiment is thus configured to close the door 5 supported by the link mechanism 15 toward the fully closed position P0 in a manner that draws a linear slide trajectory Rs as described above.

When the door 5 opens from the fully closed position P0, an operating force in the opening movement direction is applied to the door 5 in a state where the door side engagement part 31 and the vehicle body side engagement part 32 are engaged with each other. Furthermore, in this case, the variable connection length mechanism 50 moves according to the operating force in the opening movement direction, thereby shortening the connection length L of the door 5, formed by the second link arm 12, according to the engagement state between the door side engagement part 31 and the vehicle body side engagement part 32. The door device 20 of the present embodiment is thus configured to open the door 5 supported by the link mechanism 15 from the fully closed position P0 in a manner that also draws a linear slide trajectory Rs.

### <Drive Device>

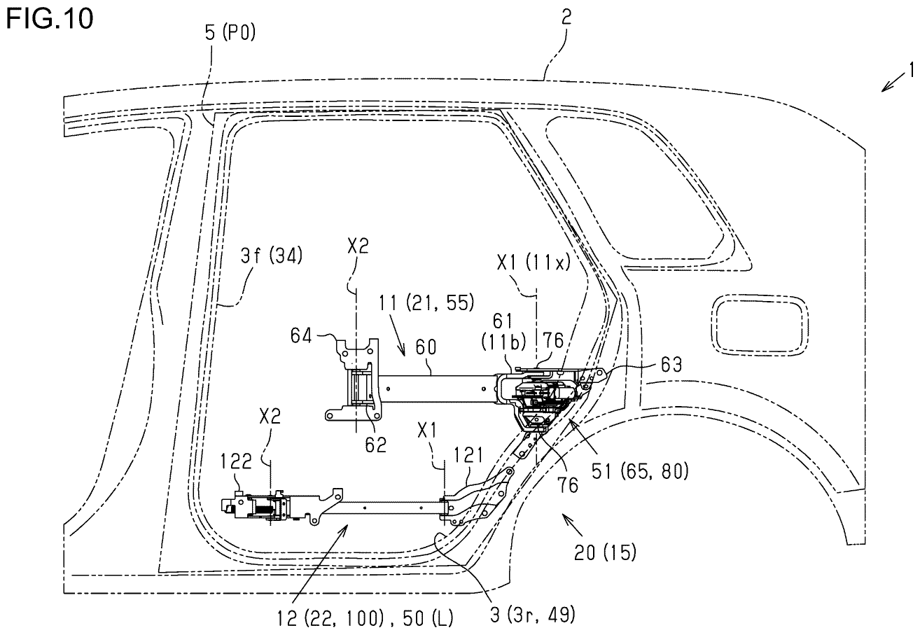

As illustrated in FIG. 10, the door device 20 of the present embodiment includes a drive device 51 that open-drives and close-drives the door 5 of the vehicle 1 supported by the link mechanism 15 formed by the first and second link arms 11, 12. In the door device 20 of the present embodiment, this drive device 51 uses the first link arm 11 positioned as the main link 21 as a drive link 55 and applies a drive torque to this first link arm 11. The drive device 51 of the present embodiment is thus configured to open and close the door 5 supported by the first link arm 11 by rotating this first link arm 11 around the first rotational connection point X1 with respect to the vehicle body 2.

In detail, in the door device 20 of the present embodiment, the first link arm 11 includes an arm body 60 having a long, abbreviated rod-like external shape. The first link arm 11 of the present embodiment also includes a base bracket 61 and a tip bracket 62 connected to the longitudinal ends of the arm body 60. Furthermore, the door device 20 of the present embodiment includes a vehicle body bracket 63 to which the base bracket 61 of the first link arm 11 is rotatably connected in a state where the door device 20 is fixed near the rear edge 3r of the door opening 3. In addition, the door device 20 of the present embodiment includes a door bracket 64 to which the tip bracket 62 of the first link arm 11 is rotatably connected in a state where the door device 20 is fixed to the door 5.

Thus, in the door device 20 of the present embodiment, the base bracket 61 and the vehicle body bracket 63 that are rotatably connected relative to each other form the first rotational connection point X1 of the first link arm 11. Furthermore, the tip bracket 62 and door bracket 64 that are also rotatably connected relative to each other form the second rotational connection point X2 of the first link arm 11. The drive device 51 of the present embodiment is thus configured to input drive torque to the base end 11b of the first link arm 11 that is rotatably supported with respect to the vehicle body 2.

Specifically, in the door device 20 of the present embodiment, by using a pair of connecting pins 76, 76, the base bracket 61, constituting the base end 11b of the first link arm 11, and the vehicle body bracket 63 are connected at two positions spaced apart in the up-down direction. The door device 20 of the present embodiment is thus configured to form a rotational axis 11x of the first link arm 11 with respect to the vehicle body 2, that is, a first rotational connection point X1, at a position passing through the axis line of the connecting pins 76, 76.

In more detail, the drive device 51 of the present embodiment includes an actuator 65 that outputs drive torque and a torque input part 80 that inputs the drive torque of the actuator 65 to the base bracket 61 that constitutes the base end 11b of the first link arm 11. Furthermore, in the door device 20 of the present embodiment, this drive device 51 is provided at an axial position between the above-described pair of connecting pins 76, 76 in a state where the drive device 51 is supported by the vehicle body bracket 63. The door device 20 of the present embodiment is thus configured to rotationally drive the first link arm 11 at a coaxial position with the rotational axis 11x of the first link arm 11 that forms the first rotational connection point X1 with respect to the vehicle body 2.

### <System Structure>

As illustrated in FIGS. 3 to 6 and 9, in the door device 20 of the present embodiment, the drive device 51 configured as described above is controlled in its operation by a control device 90. Specifically, the control device 90 of the present embodiment supplies drive power to an actuator 65 of the drive device 51, in particular, a motor 65m that serves as a drive source. Then, through the supply of drive power to this motor 65m, the control device 90 of the present embodiment controls the operation of the drive device 51 according to the rotation of the motor 65m. In other words, the control device 90 is configured to control the opening and closing movement of the door 5 supported by the link mechanism 15 formed by the first link arm 11 as the drive link 55 and the second link arm 12.

In detail, a user's operation input to an operation input part 91 provided in the door 5 of the vehicle 1, in the interior, or in a portable device is input to the control device 90 of the present embodiment as an operation input signal S1. Specifically, in the vehicle 1 of the present embodiment, the door 5 on which the door device 20 is installed is provided with a door switch 93 near the rear of the window frame as the operation input part 91. This door switch 93 may be referred to as a ‘C-pillar switch’ or the like. In addition, a capacitance sensor 94 that can detect a user's operation input in a non-contact manner is provided near the front of the window frame. The control device 90 of the present embodiment thereby detects a request by a user for operating the door 5 based on the operation input signal S1 output by the operation input part 91.

Furthermore, various control signals S2 indicating the operating state of the door 5 and the vehicle state are input to the control device 90 of the present embodiment. For example, the control device 90 of the present embodiment is input with an opening and closing movement position and speed of the door 5 as control signals S2. The control device 90 of the present embodiment controls the opening and closing movement of the door 5 according to the driving force of the drive device 51 based on these control signals S2 in addition to the above-described operation input signal S1.

In the vehicle 1 of the present embodiment, a touch sensor 95 is provided at the front end 5f of the door 5 to detect the ‘occurrence of pinching’ when the door 5 closes. As the touch sensor 95, a contact-type or capacitance-type pressure-sensitive sensor or a non-contact sensor can be used. When the control device 90 of the present embodiment detects the ‘occurrence of pinching’ based on an output signal of the touch sensor 95, the control device 90 is configured to execute control to eliminate the state of pinching, for example, by reversely driving the door 5 in the closing movement.

In the vehicle 1 of the present embodiment, an operation input signal S1 output by each operation input part 91 and control signals S2 output by the various sensor devices 96 are input to the control device 90 via an in-vehicle network 97 such as Control Area Network (CAN). Alternatively, Local Area Network (LAN) or the like can be used as the in-vehicle network 97. The in-vehicle network 97 can be configured using wireless communication as well as a wired system using a signal line.

In the vehicle 1 of the present embodiment, the control device 90 controls the operation of a closer device 98 installed in the door 5. That is, the closer device 98 has a closer function that drives the latch mechanism 47 of each lock device 45 to transition to a full latch state when the latch mechanism 47 is in a half latch state. The closer device 98 also has a release function that drives the latch mechanism 47 to transition to an unlatch state. Through the operation of this closer device 98, the control device 90 of the present embodiment controls the state of engagement and disengagement of the latch mechanism 47 constituting each lock device 45, that is, the control device 90 restrains the door 5 at the fully closed position P0 or release the restraint.

Specifically, the closer device 98 of the present embodiment is provided as an integral part of the rear lock 45R. Furthermore, in the door device 20 of the present embodiment, the driving force of this closer device 98 is transmitted to the front lock 45F via a drive cable not illustrated. The control device 90 of the present embodiment is thus able to control the operation of these rear lock 45R and front lock 45F in a state where the rear latch 47R and the front latch 47F are interlocked.

The model of the closer device 98 and the placement thereof can be changed arbitrarily. For example, the closer device 98 can be provided as an integral part of the front lock 45F. Each lock device 45 may also be provided with an independent closer device 98. Furthermore, the closer device 98 may be placed at a distance from each lock device 45. Also, a release device for releasing each lock device 45 may be provided separately from the closer device 98 that causes each lock device 45 to close.

That is, the control device 90 of the present embodiment controls the operation of the closer device 98 together with the drive device 51 based on the input of the operation input signal S1 indicating an operation request by a user. For example, the control device 90 executes release control of each lock device 45 by operation of the closer device 98 prior to open-drive control of the door 5 by operation of the drive device 51. The control device 90 also executes close control of each lock device 45 by operation of the closer device 98 subsequently after close-drive control of the door 5 by operation of the drive device 51. The door device 20 of the present embodiment is thus configured to smoothly perform the opening movement of the door 5 supported by the link mechanism 15 constituted of the first and second link arms 11, 12 from the fully closed state, and the closing movement of the door 5 to the fully closed state.

In the vehicle 1 of the present embodiment, this door 5 is also provided with an emergency release lever 99. Furthermore, this emergency release lever 99 is connected to each lock device 45 via a drive cable not illustrated. The vehicle 1 of the present embodiment can thus release the restraint of the door 5 by each lock device 45 by operating this emergency release lever 99 in the event of an emergency, such as, for example, a loss of power.

### <Articulated Link>

As described above, in the door device 20 of the present embodiment, the second link arm 12 positioned as the sub link 22 constitutes a variable link 100 with a variable connection length mechanism 50 that allows the connection length L between the first and second rotational connection points X1, X2 to be changed.

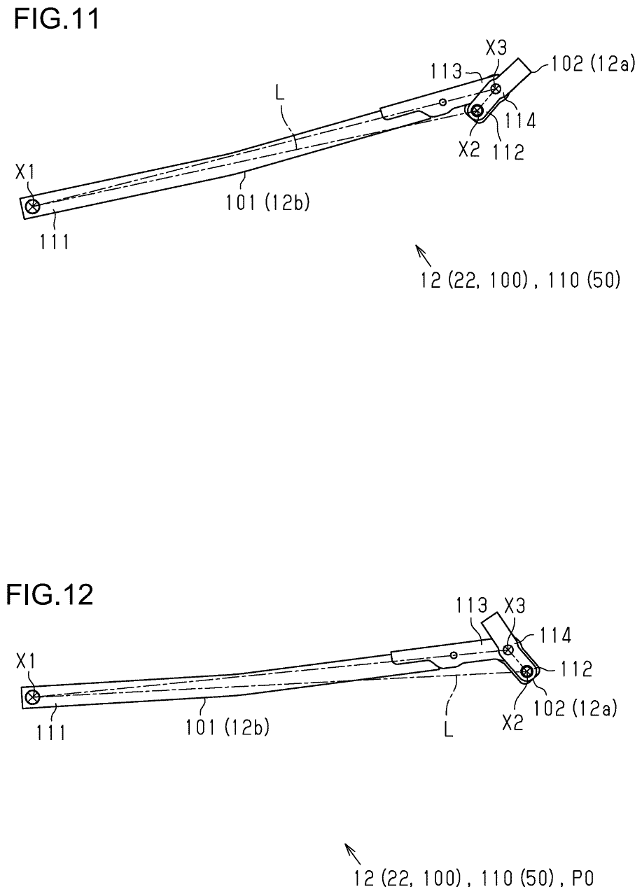

In detail, as illustrated in FIGS. 11 and 12, in the door device 20 of the present embodiment, the second link arm 12 is configured to include a vehicle body side link 101 and a door side link 102 that are connected in a relatively rotatable manner. That is, the vehicle body side link 101 constitutes a base end 12b side of the second link arm 12 having the first rotational connection point X1 with respect to the vehicle body 2. The door side link 102 constitutes a tip end 12a side of the second link arm 12 having the second rotational connection point X2 with respect to the door 5 of the vehicle 1. In the door device 20 of the present embodiment, the variable connection length mechanism 50 is formed according to the folded shape of the articulated link 110 formed thereby.

In further detail, the door side link 102 of the present embodiment has a configuration as a so-called mini-arm with a short axial length in comparison with the vehicle body side link 101. The vehicle body side link 101 has a vehicle body side connection part 111 connected to the vehicle body 2 at one end of the longitudinal direction. Furthermore, the door side link 102 also has a door side connection part 112 connected to the door 5 at one end of the longitudinal direction. These vehicle body side link 101 and door side link 102 each have, at the other end side in the longitudinal direction, intermediate connection parts 113, 114 that are connected to each other.

That is, in the door device 20 of the present embodiment, these intermediate connection parts 113, 114 form an intermediate connection point X3 of the articulated link 110 provided in the second link arm 12. In addition, the second link arm 12 forms a triangle with the vehicle body side link 101 and the door side link 102 with this intermediate connection point X3 as an apex. This configuration allows the relative rotation of these vehicle body side link 101 and door side link 102 to change the length of a straight line connecting the first and second rotational connection points X1 and X2, which is the base of the above triangle, that is, the connection length L thereof.

Specifically, the articulated link 110 of the present embodiment has a connection length L that becomes longer when the door side link 102 rotates relative to the vehicle body side link 101 in a counterclockwise direction in each drawing around the intermediate connection point X3. Then, the connection length L becomes shorter when the door side link 102 rotates relative to the vehicle body side link 101 in a clockwise direction in each drawing around the intermediate connection point X3.

### <Connection Structure of Articulated Link>

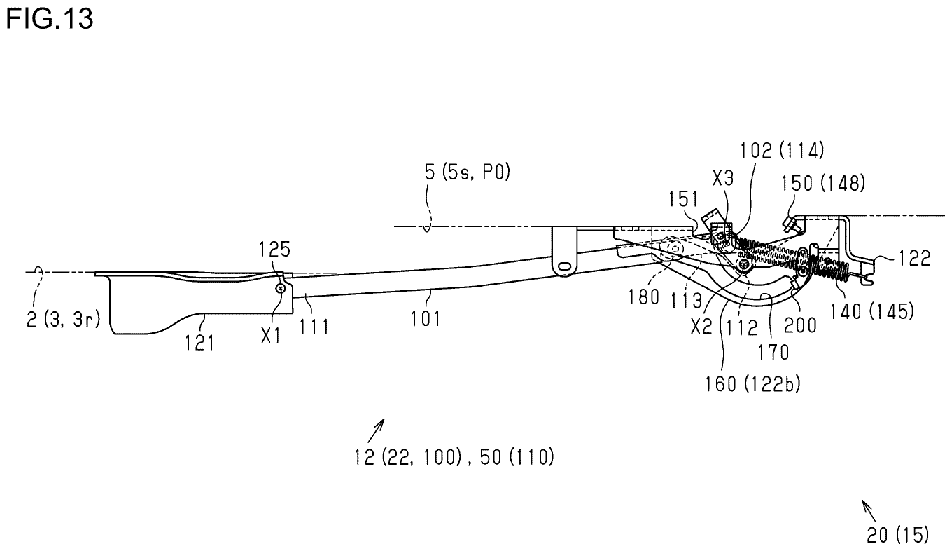

As illustrated in FIGS. 13 to 15, in the door device 20 of the present embodiment, the vehicle body side link 101 constituting the base end 12b of the second link arm 12 is connected to the vehicle body 2 via a vehicle body bracket 121. The door side link 102 that constitutes the tip end 12a of the second link arm 12 is also connected to the door 5 via a door bracket 122 fixed to the inner surface 5s of the door 5.

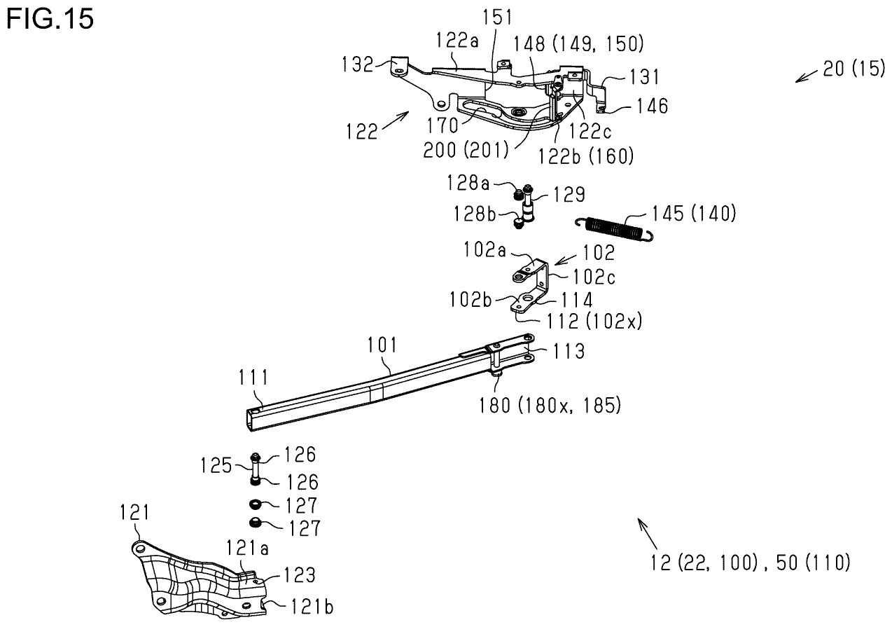

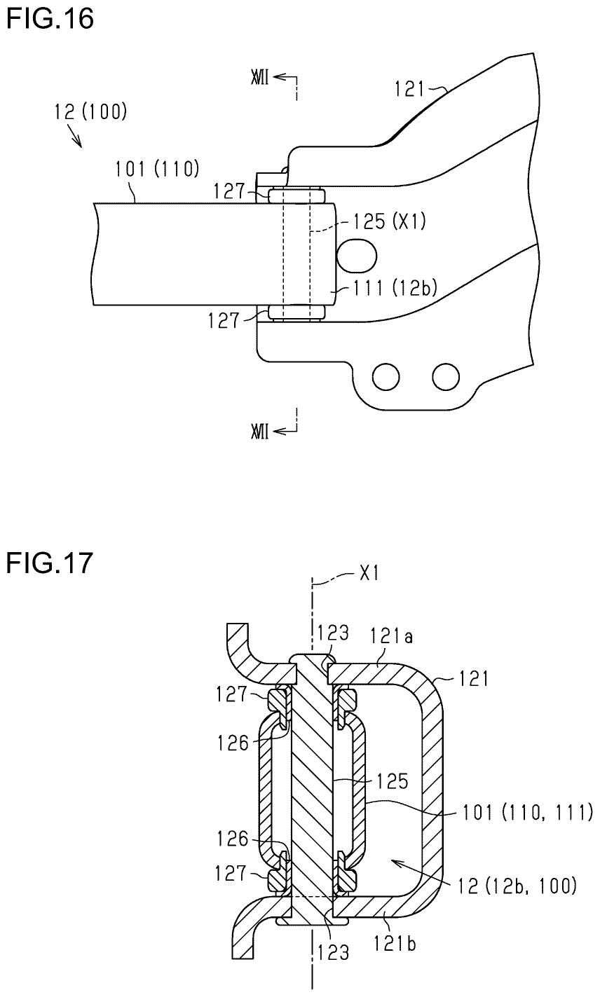

In detail, as illustrated in FIGS. 15 to 17, in the door device 20 of the present embodiment, the vehicle body side link 101 has a long, abbreviated rectangular cylindrical external shape on the side of the vehicle body side connection part 111. The vehicle body bracket 121 includes an upper wall 121a and a lower wall 121b facing each other in the up-down direction in a state where this vehicle body bracket 121 is fixed to the vehicle body 2. Furthermore, the vehicle body bracket 121 has a top and bottom pair of through holes 123, 123 provided in the upper wall 121a and the lower wall 121b. The vehicle body bracket 121 of the present embodiment includes a support shaft 125 of the vehicle body bracket 121, bridging between the upper wall 121a and the lower wall 121b thereof in a state where the support shaft 125 is inserted through these through holes 123, 123.

Specifically, as illustrated in FIG. 17, in the door device 20 of the present embodiment, a pair of collars 127, 127 having an abbreviated flat cylindrical shape are attached to a through hole provided in the vehicle body side connection part 111 of the vehicle body side link 101. Furthermore, the support shaft 125 is inserted into the cylinders of these collars 127, 127 via bushings 126, 126. The door device 20 of the present embodiment stably supports the vehicle body side link 101 around this support shaft 125 by expanding the contact area of each bush 126, 126. In other words, the vehicle body side link 101 and the vehicle body bracket 121 are configured to form the first rotational connection point X1 with respect to the vehicle body 2.

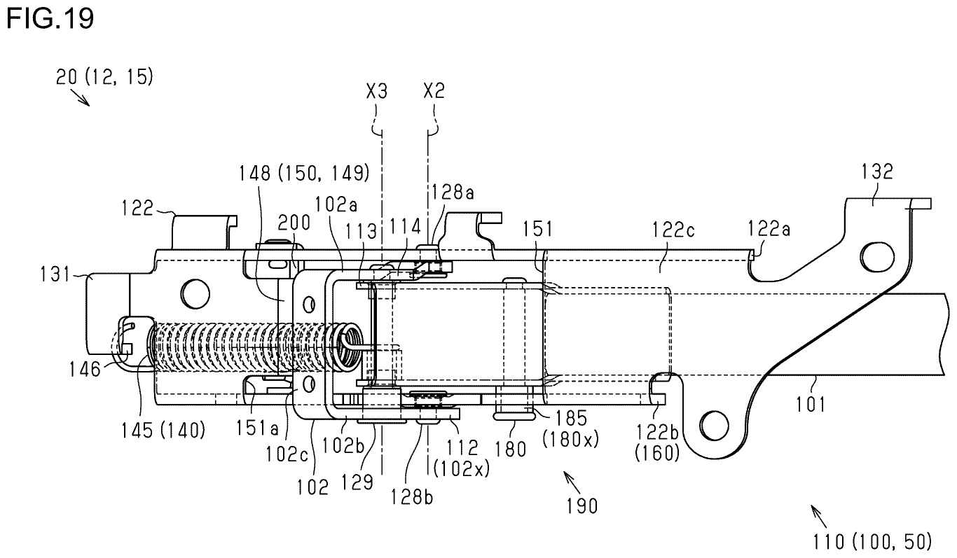

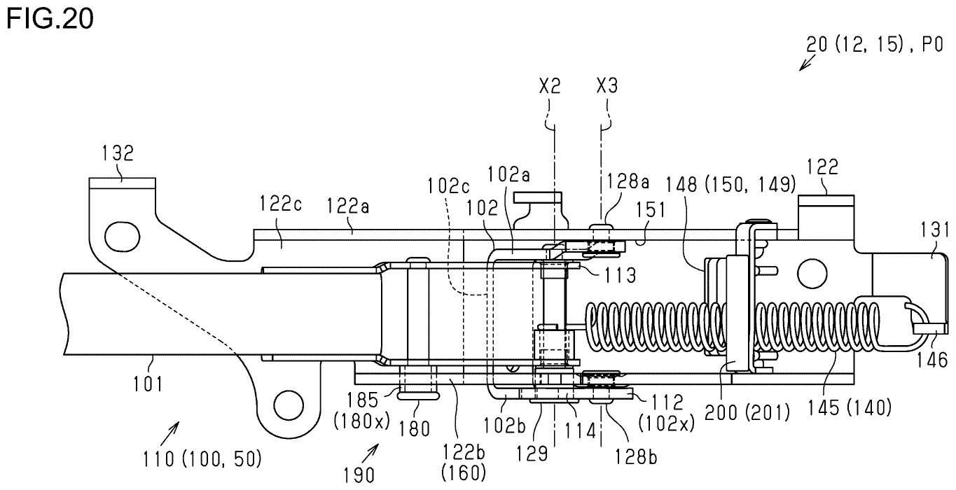

As illustrated in FIGS. 15 and 18 to 23, in the door device 20 of the present embodiment, the door side link 102 has an upper wall section 102a and a lower wall 102b facing each other in the up-down direction. Furthermore, this door side link 102 has an abbreviated U-shaped folded plate shape with an end wall section 102c connecting these upper wall section 102a and lower wall 102b at one end in the longitudinal direction. The door side link 102 of the present embodiment is thus configured with the longitudinal end opposite to the end wall section 102c as an open end 102x, and the vicinity of this open end 102x is rotatably connected to the door bracket 122.

In detail, the door bracket 122 of the present embodiment includes an upper wall 122a and a lower wall 122b facing each other in the up-down direction in a state where this door bracket 122 is fixed to the inner surface 5s of the door 5. Furthermore, in the door side link 102 of the present embodiment, the upper wall section 102a near the open end 102x is connected to the upper wall 122a of this door bracket 122, and the lower wall 102b near the open end 102x is connected to the lower wall 122b of the door bracket 122. The door device 20 of the present embodiment is thus configured such that the door side link 102 and the door bracket 122 form the second rotational connection point X2 with respect to the door 5 with the open end 102x of the door side link 102 as the door side connection part 112.

Specifically, the door device 20 of the present embodiment includes an upper connection member 128a that rotatably connects the upper wall section 102a of the door side link 102 to the upper wall 122a of the door bracket 122. The door device 20 also includes a lower connection member 128b that rotatably connects the lower wall 102b of the door side link 102 to the lower wall 122b of the door bracket 122. The door device 20 of the present embodiment is thus configured to form the second rotational connection point X2 with respect to the door 5 at a coaxial position with these upper connection member 128a and lower connection member 128b.

The door side link 102 of the present embodiment includes a connection shaft 129 bridging between the upper wall 122a and the lower wall 122b at a longitudinal intermediate position of this door side link 102. Furthermore, in the door device 20 of the present embodiment, the intermediate connection part 113 of the vehicle body side link 101 is rotatably connected to this connection shaft 129. The door device 20 of the present embodiment is thus configured to form an intermediate connection point X3 between the door side link 102 and the vehicle body side link 101 with the longitudinal intermediate position where the connection shaft 129 is provided as the intermediate connection part 114 of the door side link 102.

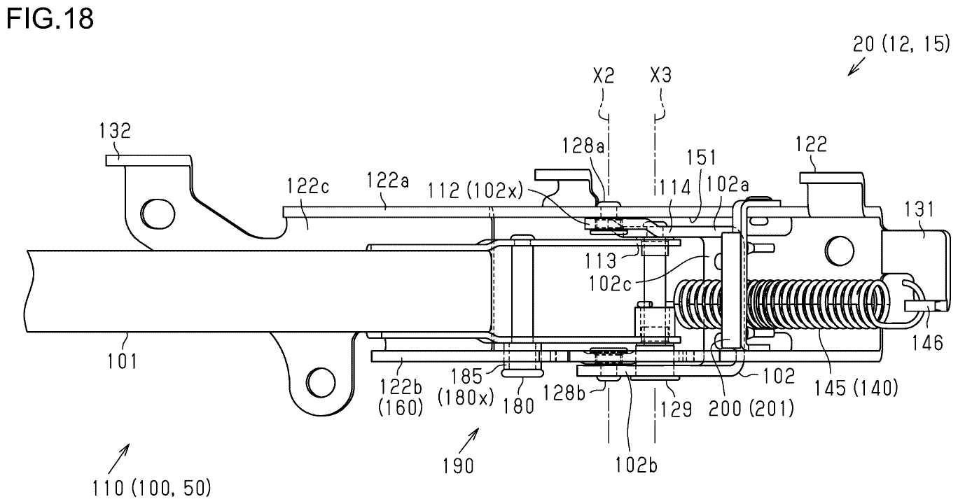

In more detail, in the door bracket 122 of the present embodiment, in a state where the door bracket 122 is fixed to the door 5, the first end 131 in the longitudinal direction is placed on the front side of the vehicle (the right side in FIGS. 18, 20 to 23), and the second end 132 is placed on the rear side of the vehicle (the left side in each drawing). In other words, the door bracket 122 of the present embodiment is configured such that the first end 131 in the longitudinal direction is placed on the closing side in the opening width direction of the door opening 3, and the second end 132 is placed on the opening side in the opening width direction of the door opening 3.

The door bracket 122 of the present embodiment has an abbreviated U-shaped external shape in cross-section with a vertical wall 122c connecting the upper wall 122a and the lower wall 122b. Furthermore, the door bracket 122 of the present embodiment has a connection position of the door side link 102 connected to the door bracket 122, that is, a second rotational connection point X2 with respect to the door 5, at a distance from the vertical wall 122c. In the door device 20 of the present embodiment, in a state where the door side link 102 rotates around this second rotational connection point X2, the intermediate connection part 114 with the vehicle body side link 101 is placed closer to the vertical wall 122c of the door bracket 122 than the door side connection part 112 is. In other words, the door side link 102 is configured to rotate around the second rotational connection point X2 in a state where the intermediate connection point X3 with the vehicle body side link 101 is placed closer to the inner surface 5s of the door 5 than the second rotational connection point X2 with respect to the door 5 is.

### <Door Side Link Energizing Structure>

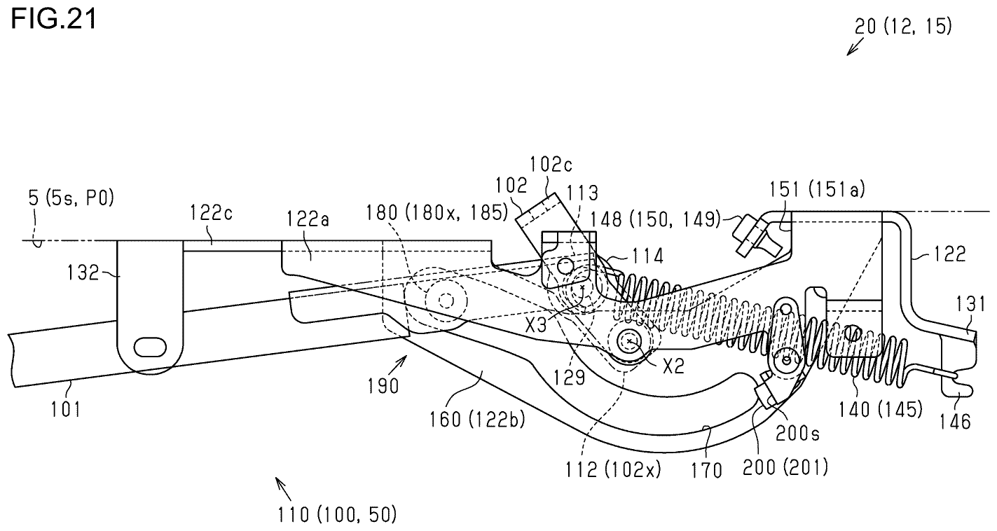

The door device 20 of the present embodiment also includes an energizing member 140 that applies a rotational force to the door side link 102 around the second rotational connection point X2 with respect to the door 5, formed by the door bracket 122. Furthermore, in the door device 20 of the present embodiment, the door side link 102 rotates in a clockwise direction in FIGS. 21 to 23 according to the energizing force of this energizing member 140. The door device 20 of the present embodiment is configured such that the rotation of the door side link 102, energized by this energizing member 140, shortens the connection length L of the articulated link 110 formed by the door side link 102.

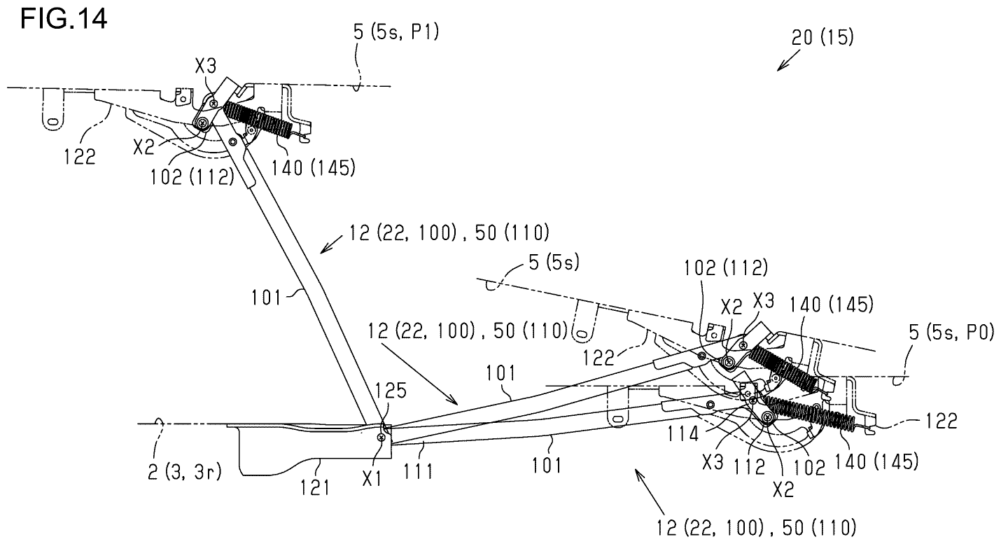

In detail, as illustrated in FIGS. 14 and 21, in the door device 20 of the present embodiment, the articulated link 110 constituting the second link arm 12 has the connection length L extended when the door 5 supported by the link mechanism 15 is at the fully closed position P0 (refer to FIG. 12). Furthermore, at this time, the door side link 102 where the door side connection part 112 is rotatably supported around the second rotational connection point X2 formed by the door bracket 122 is in a state of rotating in a counterclockwise direction in FIG. 21 against the energizing force of the energizing member 140. In the door device 20 of the present embodiment, in this state, the intermediate connection point X3 with the vehicle body side link 101, formed on the side of the intermediate connection part 114 of the door side link 102, is placed on the second end 132 side in the longitudinal direction of the door bracket 122 than the second rotational connection point X2.

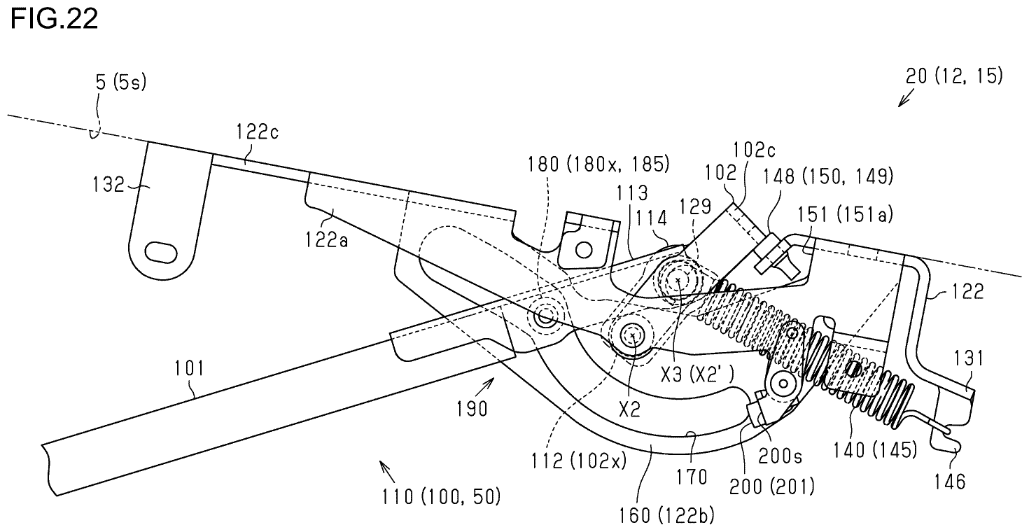

As illustrated in FIGS. 21 and 22, in the door device 20 of the present embodiment, opening movement of the door 5 from the fully closed position P0 allows the articulated link 110 constituting the second link arm 12 to change in a direction of shortening the connection length L. The door device 20 of the present embodiment thereby causes the door side link 102 to rotate in a clockwise direction in FIGS. 21 to 23 around the second rotational connection point X2 formed by the door bracket 122 according to the energizing force of the energizing member 140.

Furthermore, the door side link 102 of the present embodiment, by rotating around the second rotational connection point X2, moves the intermediate connection part 114 that forms the intermediate connection point X3 with the vehicle body side link 101 toward the first end 131 in the longitudinal direction of the door bracket 122. Thus, in the door device 20 of the present embodiment, the door side link 102 rotates relative to the vehicle body side link 101 in a clockwise direction in each drawing around the intermediate connection point X3. As a result, the connection length L is shortened.

In more detail, as illustrated in FIGS. 18 to 23, in the door device 20 of the present embodiment, a tensile coil spring 145 is used as the energizing member 140 of the door side link 102. Specifically, this tensile coil spring 145 has one end side moored to an anchoring part 146 provided on the first end 131 of the door bracket 122. The other end of this tensile coil spring 145 is moored to the connection shaft 129 provided on the door side link 102 for connection to the vehicle body side link 101. That is, in the door device 20 of the present embodiment, this tensile coil spring 145 generates a tensile force that pulls the connection shaft 129 that forms the intermediate connection point X3 with the vehicle body side link 101 toward the first end 131 in the longitudinal direction of the door bracket 122. The door device 20 of the present embodiment is configured, according to the tensile force of this tensile coil spring 145, to apply a rotational force to the door side link 102 in the clockwise direction in FIGS. 21 to 23 around the second rotational connection point X2 with respect to the door 5, formed by the door bracket 122.

### <Rotation Regulating Part>

As illustrated in FIGS. 18, 19, 22, and 23, in the door device 20 of the present embodiment, the door bracket 122 includes a stopper part 148 that contacts the door side link 102 that rotates around the second rotational connection point X2 when the door 5 opens. Furthermore, in the door device 20 of the present embodiment, the stopper part 148 is provided with a cushioning member 149 having an abbreviated flat plate-like external shape. The door device 20 of the present embodiment is thus configured to regulate the relative rotation of the door side link 102 to the door 5 around the second rotational connection point X2 by using this stopper part 148 as the rotation regulating part 150.

In detail, the door bracket 122 of the present embodiment has a notch 151 in the vertical wall 122c. Furthermore, the door bracket 122 supports the open end 102x side of the door side link 102 that constitutes the door side connection part 112 in a state where the end wall section 102c side of the door side link 102 is placed in this notch 151. Then, the door bracket 122 of the present embodiment is configured to place the stopper part 148 that acts as the rotation regulating part 150 in the peripheral edge 151a of the notch 151 located on the first end 131 side in the longitudinal direction of this door bracket 122.

That is, the end wall section 102c of the door side link 102 is placed farther away from the open end 102x that forms the second rotational connection point X2 by being supported by the door bracket 122 than the connection shaft 129 that forms the intermediate connection point X3 with the vehicle body side link 101. Therefore, as the door side link 102 rotates around the second rotational connection point X2 according to the tensile force of the tensile coil spring 145, the end wall section 102c also moves toward the first end 131 side in the longitudinal direction within the notch 151 of the door bracket 122. In the door device 20 of the present embodiment, this causes the end wall section 102c of the door side link 102 to contact the stopper part 148 provided in the peripheral edge 151a of the notch 151.

Furthermore, in the door device 20 of the present embodiment, in this state, the end wall section 102c of the door side link 102 is pressed against the stopper part 148 according to the energizing force of the tensile coil spring 145. The door device 20 of the present embodiment is thus configured to regulate the relative rotation of the door side link 102 to the door 5 around the second rotational connection point X2.

In the door device 20 of the present embodiment, the door bracket 122 is placed at a position where the notch 151 provided in the vertical wall 122c faces the recess in the inner surface 5s of the door 5. In this way, the end wall section 102c side of the door side link 102 that moves within the notch 151 does not interfere with the inner surface 5s of the door 5.

The door device 20 of the present embodiment allows elastic deformation of the cushioning member 149 provided in the stopper part 148 in a state where the end wall section 102c of the door side link 102 is in contact with the stopper part 148. The door device 20 of the present embodiment thereby suppresses generation of contact noise against the stopper part 148, and also enables stable retention of the door side link 102 pressed against the stopper part 148.

In more detail, as illustrated in FIG. 22, in the door device 20 of the present embodiment, the rotation of the door side link 102 around the second rotational connection point X2 is regulated, thereby changing the changing form of the connection length L according to the movement of the articulated link 110 that constitutes the variable connection length mechanism 50. That is, the door side link 102 is pressed against the stopper part 148 of the door bracket 122 according to the energizing force of the energizing member 140 such that the door side link 102 becomes integrated with the door 5. This causes the door 5 to open and close in a state where this vehicle body side link 101 relatively rotates around the intermediate connection point X3 of the articulated link 110, that is, the intermediate connection point X3 between the door side link 102 and the vehicle body side link 101.

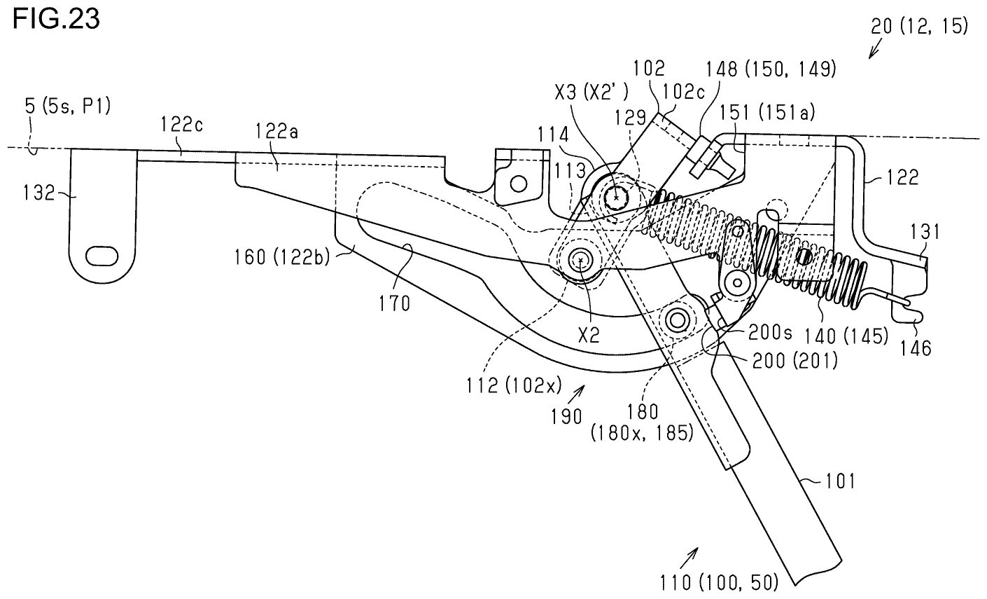

Thus, as illustrated in FIGS. 22 and 23, the intermediate connection point X3 apparently becomes another second rotational connection point X2′ with respect to the door 5. In other words, that second rotational connection point X2 with respect to the door 5 is transitioned. The door device 20 of the present embodiment is thus configured to open and close the door 5 supported by the link mechanism 15 in a state where the connection length L between the first and second rotational connection points X1, X2 is fixed at a certain value according to the length of the vehicle body side link 101.

In the door device 20 of the present embodiment, the size of the gap between the upper wall section 102a and the lower wall 102b of the door side link 102 facing each other in the up-down direction is wider than the height in the up-down direction at the intermediate connection part 113 of the vehicle body side link 101. The door device 20 of the present embodiment thus allows the vehicle body side link 101 to rotate around the intermediate connection point X3 with the door side link 102 without interference of the vehicle body side link 101 to the door side link 102.

In the door device 20 of the present embodiment, the connection shaft 129 that forms the intermediate connection point X3 and the tensile coil spring 145 in a state of being moored to the anchoring part 146 of the door bracket 122 are placed along the longitudinal direction of the door bracket 122. Furthermore, in the vehicle body side link 101 of the present embodiment, the intermediate connection part 113 that constitutes the intermediate connection point X3 with the door side link 102 has an abbreviated U-shaped external shape in cross section and a U-shaped inner dimension that is larger than the coil diameter of the tensile coil spring 145. The door device 20 of the present embodiment thus utilizes this structure to place the tensile coil spring 145 at a height position that overlaps the intermediate connection part 113 of the vehicle body side link 101 in the up-down direction along the connection shaft 129 that forms the intermediate connection point X3.

Specifically, the door device 20 of the present embodiment places the tensile coil spring 145 between the upper wall 122a and lower wall 122b of the door bracket 122 at a height position almost equal to that of the vehicle body side link 101. The door device 20 of the present embodiment is thus configured to make it difficult for foreign objects to interfere with the tensile coil spring 145 that constitutes the energizing member 140 of the door side link 102, regardless of the rotational position of the vehicle body side link 101.

### <Engagement Projection on the Vehicle Body Side Link and Cam Groove in the Door Bracket>

As illustrated in FIGS. 15, 20 to 23, in the door device 20 of the present embodiment, the door bracket 122 has the upper wall 122a and the lower wall 122b forming an abbreviated U-shape in cross section, where the lower wall 122b has a larger flat plate shape than the upper wall 122a. The door bracket 122 of the present embodiment includes a cam groove 170 provided in a manner that penetrates this lower wall 122b in the thickness direction, with the lower wall 122b as a cam member 160 provided on the door 5.

In the door device 20 of the present embodiment, the vehicle body side link 101 is provided with an engagement member 180 having an engagement part 180x to be engaged with this cam groove 170. The door device 20 of the present embodiment is configured such that the cam mechanism 190 formed by these cam groove 170 and engagement member 180 regulates the opening and closing movement of the door 5 supported by the second link arm 12 configured as the articulated link 110.

In detail, in the door device 20 of the present embodiment, the engagement member 180 on the side of the vehicle body side link 101 has an abbreviated axial external shape that protrudes below the vehicle body side link 101 in a state where the engagement member 180 passes through in the up-down direction the intermediate connection part 113 with the door side link 102. Furthermore, this engagement member 180 has a roller 185 rotatable around its axis. The engagement member 180 of the present embodiment is thus configured to have this roller 185 as the engagement part 180x to be engaged with the cam groove 170 provided in the lower wall 122b of the door bracket 122.

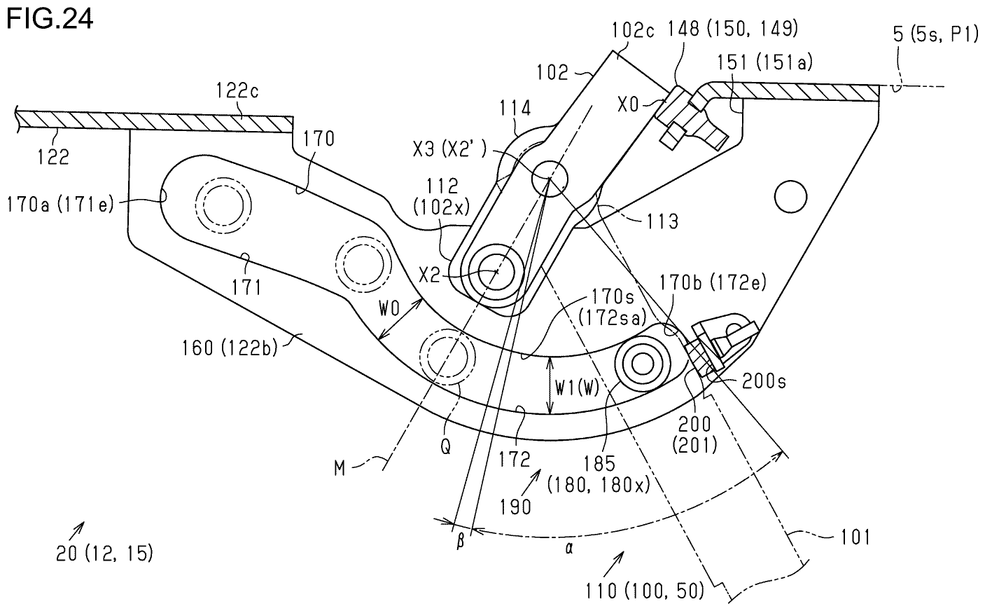

As illustrated in FIG. 24, in the door device 20 of the present embodiment, the lower wall 122b of the door bracket 122 that constitutes the cam member 160 is provided with a first groove section 171 and a second groove section 172 that extend along the longitudinal direction of this door bracket 122.

In detail, in the door bracket 122 of the present embodiment, these first groove section 171 and second groove section 172 are provided in a manner that penetrates the lower wall 122b in the thickness direction. The first groove section 171 has an abbreviated straight groove shape extending along the longitudinal direction of the door bracket 122, on the second end 132 side than a position where this door bracket 122 forms the second rotational connection point X2. Further, the second groove section 172 has an abbreviated arcuate groove shape that is convex in a direction away from the vertical wall 122c of the door bracket 122 placed along the inner surface 5s of the door 5. The door bracket 122 of the present embodiment has the cam groove 170 provided in the lower wall 122b in a manner that connects these first groove section 171 and the second groove section 172, forming an extension region extending in the longitudinal direction of the door bracket 122. In other words, the cam groove 170 of the cam member 160 provided on the door 5 is configured to extend in the front-back direction of the vehicle that is the opening width direction of the door opening 3.

That is, in the door device 20 of the present embodiment, the vehicle body side link 101 that constitutes the articulated link 110 rotates around the first rotational connection point X1 with respect to the vehicle body 2, while rotating relative to the door side link 102 around the intermediate connection point X3 according to the opening and closing movement of the door 5. Furthermore, in the door device 20 of the present embodiment, the door side link 102 rotates around the second rotational connection point X2 with respect to the door 5 at an opening and closing movement position near the fully closed position P0 where the door side engagement part 31 and the vehicle body side engagement part 32 are engaged with each other. The door device 20 of the present embodiment is thus configured such that the engagement part 180x of the engagement member 180 placed in the cam groove 170 moves within the first groove section 171 in a range in which the door 5 opens and closes drawing a linear slide trajectory Rs.

In the door device 20 of the present embodiment, when the door side link 102 is pressed against the door bracket 122 as described above, the rotation of the door side link 102 around the second rotational connection point X2 with respect to the door 5 is regulated. The door device 20 of the present embodiment is thus configured such that the engagement part 180x of the engagement member 180 placed in the cam groove 170 moves within the second groove section 172 in a range in which the door 5 opens and closes drawing an arcuate glide trajectory Rg.

In other words, the door device 20 of the present embodiment has an opening and closing movement position of the door 5 where the opening and closing movement trajectory R of the door 5 shifts from the slide trajectory Rs to the glide trajectory Rg or from the glide trajectory Rg to the slide trajectory Rs (refer to FIGS. 3 to 6). The door device 20 of the present embodiment is thus configured such that the engagement part 180x of the engagement member 180 placed in the cam groove 170 passes through the connection position of the first groove section 171 and the second groove section 172 upon shifting of this opening and closing movement trajectory R.

In the door device 20 of the present embodiment, the movement of the articulated link 110 is restricted by the engagement of the engagement member 180 provided on the vehicle body side link 101 with the cam groove 170 of the cam member 160 provided on the door 5. Specifically, the relative rotation of the vehicle body side link 101 and the door side link 102 is restricted according to the engagement position of the engagement member 180 within the cam groove 170, that is, the position of the roller 185 that acts as the engagement part 180x. Also, based on the position of the roller 185 within the cam groove 170, the rotation of the door 5 around the second rotational connection point X2 formed by the door side link 102 is regulated. The door device 20 of the present embodiment is thus able to open and close the door 5 in a stable posture that suppresses sway and vibration of the door 5.

### <Groove Width Change Section of Cam Groove>

In the door device 20 of the present embodiment, the roller 185 of the engagement member 180 placed in the cam groove 170 moves within the cam groove 170 according to the full closing movement of the door 5, thereby coming into close proximity to the extension end 171e of the first groove section 171. Then, the roller 185 of the engagement member 180 that has moved within the cam groove 170 according to the full opening movement of the door 5, comes into close proximity to the extension end 172e of the second groove section 172.

That is, in the cam groove 170 of the present embodiment, the extension end 171e of the first groove section 171 located on the closing side (the left side in FIG. 24) of the extension region extending in the opening width direction of the door opening 3 becomes the closing side end 170a according to the placement of the door bracket 122 fixed to the inner surface 5s of the door 5. The extension end 172e of the second groove section 172 located on the opening side (the right side in FIG. 24) of the extension region extending in the opening width direction of the door opening 3 becomes the opening side end 170b.

In the door device 20 of the present embodiment, the cam groove 170 has a groove width change section α set on the opening side of the extension region including the opening side end 170b. In the door device 20 of the present embodiment, the groove width W1 of the cam groove 170 in this groove width change section α is set narrower than the groove width W0 of the cam groove 170 that is on the closing side of the extension region than the groove width change section α (W1<W0).

In detail, in the door device 20 of the present embodiment, this groove width change section α is provided in the second groove section 172 having the opening side end 170b of the cam groove 170. In the door device 20 of the present embodiment, the placement of the groove width change section α is set according to the folded shape of the articulated link 110 that changes according to the opening and closing movement of the door 5, that is, the relative rotation state of the vehicle body side link 101 and the door side link 102 that constitute the articulated link 110.

Specifically, in the door device 20 of the present embodiment, a straight line passing through the intermediate connection point X3 between the vehicle body side link 101 and the door side link 102 and the second rotational connection point X2 is defined as a reference line M. That is, as described above, the rotation of the door side link 102 around the second rotational connection point X2 is regulated by the stopper part 148 as the rotation regulating part 150 such that the vehicle body side link 101 apparently rotates relative to the door 5 around the intermediate connection point X3. Furthermore, in the door device 20 of the present embodiment, a position where the roller 185 of the engagement member 180 provided on the vehicle body side link 101 engages with the cam groove 170 when the vehicle body side link 101 rotates around the intermediate connection point X3 beyond the above-described reference line M in this state is defined as a reference position Q. The cam groove 170 of the present embodiment is configured such that the groove width change section α is on the opening side of the extension region than this reference position Q.

That is, in the groove width change section α, the narrow groove width W1 set in this groove width change section α, facilitates the roller 185 of the engagement member 180 placed in the cam groove 170 to be engaged in a state where the roller 185 is in contact with the side wall surface 170s of the cam groove 170. In detail, the roller 185 of the engagement member 180 is easily engaged in a state where the roller 185 is pressed against the inner arcuate wall surface 172sa of the second groove 172 having an abbreviated arcuate groove shape. The door device 20 of the present embodiment can thus effectively suppress the sway and vibration of the door 5.

In the door device 20 of the present embodiment, the reaction force generated by the roller 185 of the engagement member 180 pressed against the inner arcuate wall surface 172sa of the cam groove 170 is transmitted to the door side link 102 via the vehicle body side link 101. In the door device 20 of the present embodiment, a direction of the force acting on the door side link 102 according to the reaction force of the roller 185 pressed against the inner arcuate wall surface 172sa of the cam groove 170 varies according to the folded shape of the articulated link 110.

Specifically, when the roller 185 in the cam groove 170 is located on the opening side of the extension region than the above-described reference position Q, the reaction force of this roller 185 acts in a direction of pressing the door side link 102 against this stopper part 148 at a contact point X0 with the stopper part 148. Furthermore, the door device 20 of the present embodiment allows elastic deformation of the stopper part 148 against which this door side link 102 is pressed, in particular, elastic deformation of the cushioning member 149 provided in this stopper part 148. This mitigates the reaction force generated by the roller 185 of the engagement member 180 pressed against the inner arcuate wall surface 172sa of the cam groove 170 at the contact point X0 of the door side link 102 against this stopper part 148.

When the roller 185 in the cam groove 170 is located on the closing side of the extension region than the above-described reference position Q, the reaction force of the roller 185 acts in a direction of separating the door side link 102 from the stopper part 148 at the contact point X0 with the stopper part 148. Thus, it is difficult to obtain the posture stabilizing effect of the door 5 by setting a groove width W1 narrower on the closing side of the extension region than the reference position Q.

When the roller 185 in the cam groove 170 is at the reference position Q, the vehicle body side link 101 and the door side link 102 that constitute the articulated link 110 are placed on the reference line M. Thus, the reaction force of the roller 185 cannot be mitigated by the articulated link 110. That is, in this state, the reaction force generated by the roller 185 of the engagement member 180 pressed against the inner arcuate wall surface 172sa of the cam groove 170 acts on the intermediate connection point X3 between the vehicle body side link 101 and the door side link 102 and the second rotational connection point X2. As a result, when a narrow groove width W1 is set at this reference position Q, it becomes difficult for the vehicle body side link 101 to smoothly rotate around the intermediate connection point X3 beyond the reference line M.

In consideration of this point, the door device 20 of the present embodiment has the groove width change section α on the opening side of the extension region than the reference position Q that is set in the cam groove 170 based on the reference line M passing through the intermediate connection point X3 and the second rotational connection point X2 of the articulated link 110. The door device 20 of the present embodiment is thus configured such that the roller 185 can smoothly move within the groove width change section α in a state where the roller 185 of the engagement member 180 located in the groove width change section α is pressed against the inner arcuate wall surface 172sa of the cam groove 170. In other words, the door 5 supported by the second link arm 12 configured as the articulated link 110 including the cam mechanism 190 formed by the cam groove 170 and the engagement member 180 can smoothly open and close.

The cam groove 170 of the present embodiment has a gradual change section β in which the groove width W gradually narrows toward the opening side of the extension region (the right side in FIG. 24). In the cam groove 170 of the present embodiment, this gradual change section β is provided in a boundary region adjacent to the groove width change section α. That is, this gradual change section β gradually narrows its groove width W from the closing side toward the opening side of the extension region, from the groove width W0 of the cam groove 170 on the closing side of the extension region than the gradual change section β to the groove width W1 of the gradual change section β. The door device 20 of the present embodiment is thus configured to enable the roller 185 of the engagement member 180 that moves within the cam groove 170 according to the opening movement of the door 5 to smoothly enter the groove width change section α.

### <Door Stopper>

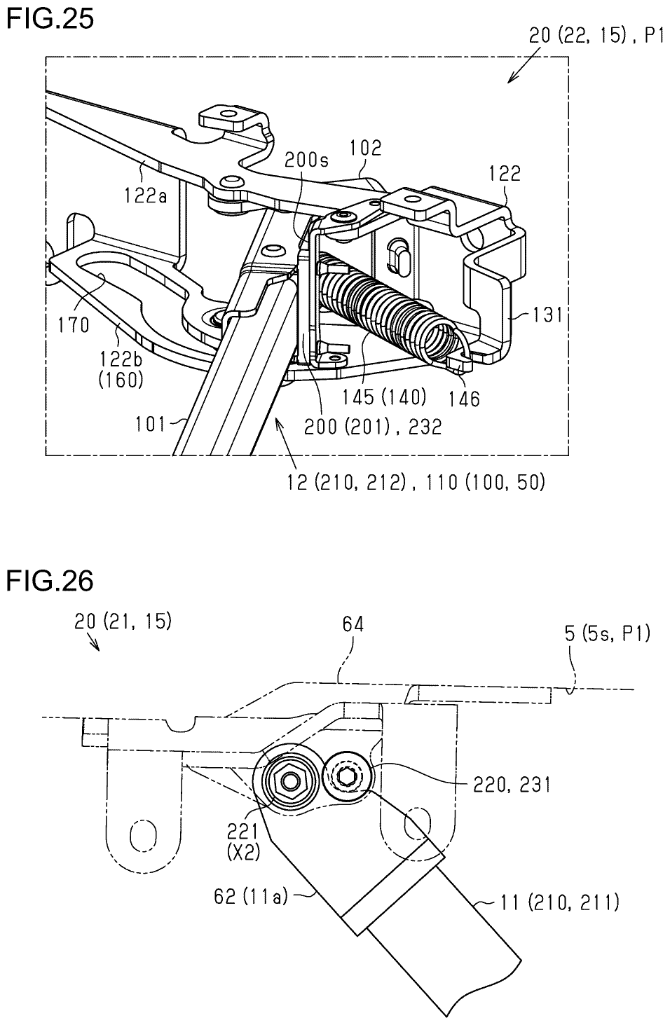

As illustrated in FIGS. 24 and 25, the door device 20 of the present embodiment includes a door stopper 200 provided on the door bracket 122. In the door device 20 of the present embodiment, this door stopper 200 has an abbreviated flat plate-like external shape that bridges over the upper wall 122a and lower wall 122b of the door bracket 122. In addition, this door stopper 200 has a contact surface 200s to which a cushioning member 201 having an abbreviated flat plate-like external shape is adhered. Furthermore, this door stopper 200 is erected near the opening side end 170b of the cam groove 170 provided in the lower wall 122b of the door bracket 122. In the door stopper 200 of the present embodiment, the second link arm 12 supporting the door 5 is thus in contact with the contact surface 200s at the fully open position P1 of the door 5. In particular, the vehicle body side link 101 that constitutes the articulated link is configured to be in contact with the contact surface 200s.

That is, in the door device 20 of the present embodiment, this door stopper 200 uses the second link arm 12 connected to the door 5 via the door bracket 122 as a contact link 210. Furthermore, at the fully open position P1 of the door 5, the relative rotation of this second link arm 12 and the door 5 is regulated by the contact of the second link arm 12 against this door stopper 200. The door device 20 of the present embodiment is thus configured to stably support the door 5 supported by the second link arm 12 at the fully open position P1.

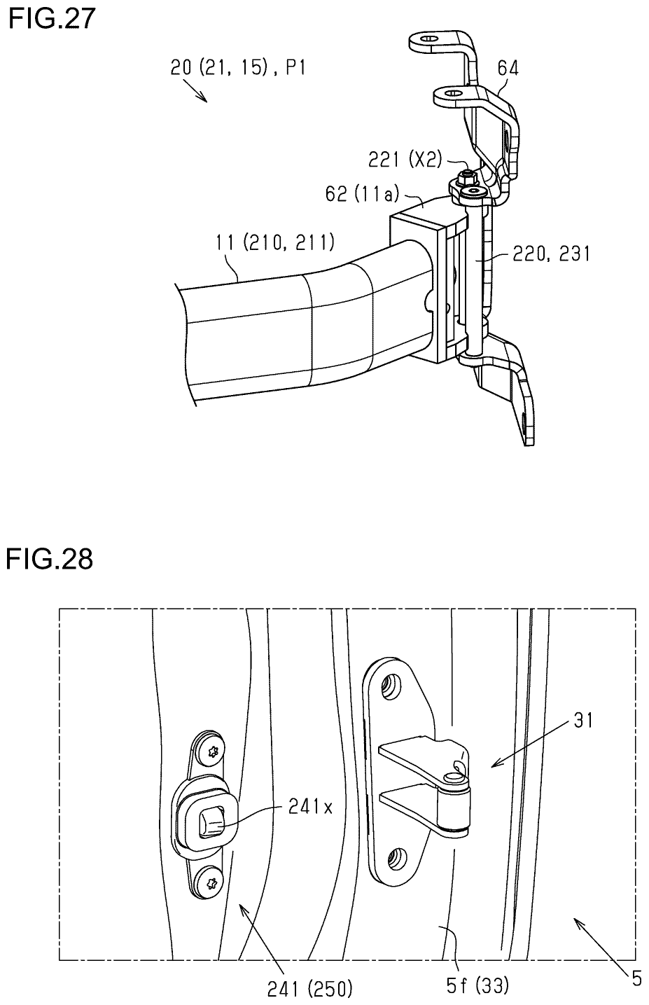

As illustrated in FIGS. 26 and 27, the door device 20 of the present embodiment includes a door stopper 220 provided on the door bracket 64 on the first link arm 11 side. In the door device 20 of the present embodiment, this door stopper 220 is fixed to the door bracket 64 in a state where the door stopper 220 extends in the up-down direction parallel to the support shaft 221 of the first link arm 11 provided on the door bracket 64. The door stopper 220 of the present embodiment is configured to be in contact with the first link arm 11, in particular, the base bracket 61 constituting the tip end 11a, at the fully open position P1 of the door 5.

That is, in the door device 20 of the present embodiment, the door stopper 220 uses the first link arm 11 connected to the door 5 via the door bracket 64 as the contact link 210. Furthermore, at the fully open position P1 of the door 5, the first link arm 11 is in contact with this door stopper 220, thereby regulating the relative rotation of this first link arm 11 and the door 5. The door device 20 of the present embodiment is thus configured to more stably support the door 5 supported by the first link arm 11 at the fully open position P1.

In more detail, in the door device 20 of the present embodiment, only the door stopper 220 that uses the first link arm 11 as the contact link 210 is in contact with the first link arm 11 when the door 5 that has opened reaches the fully open position P1. That is, in this state, the door stopper 220 that uses the second link arm 12 as the contact link 210 is not in contact with the second link arm 12. Then, in the door device 20 of the present embodiment, in a state where the door stopper 220 is in contact with this first link arm 11, the door 5 and the second link arm 12 further rotates relative to each other such that the door stopper 220 becomes in contact with the second link arm 12.

In other words, in the door device 20 of the present embodiment, the first link arm 11 positioned as the main link 21 is defined as the first contact link 211, and the door stopper 220 to be in contact with this first link arm 11 is defined as the first door stopper 231. The second link arm 12 positioned as the sub link 22 is defined as the second contact link 212, and the door stopper 200 to be in contact with this second link arm 12 is defined as the second door stopper 232. The door device 20 of the present embodiment is thus configured such that when the second contact link 212 and the door 5 are rotated relative to each other in a state where the first contact link 211 is in contact with the first door stopper 231, the second door stopper 232 becomes in contact with the second contact link 212.

That is, the door device 20 that supports the door 5 by the link mechanism 15 including the first and second link arms 11, 12, allow these first and second link arms 11, 12 to move independently from each other in consideration of tolerances and assembly errors. In addition, in a configuration using the variable link 100 having the variable connection length mechanism 50, the variable link 100 is likely to move independently.

In consideration of this point, the door device 20 of the present embodiment, at the fully open position P1 of the door 5, prioritizes the contact of the first door stopper 231 and the first contact link 211, of the first door stopper 231 and the second door stopper 232 provided on the door 5. The door device 20 of the present embodiment thereby secures a constant support posture by the link mechanism 15 at the fully open position P1 of the door 5.

Furthermore, in the door device 20 of the present embodiment, both the first door stopper 231 and the second door stopper 232 contact their corresponding first contact link 211 and second contact link 212, respectively, and, at the same time, can regulate their relative rotation to the door 5. The door device 20 of the present embodiment is thus able to stably support the door 5 at the fully open position P1, for example, when an external force acts on the door 5.

### <Down Stopper>

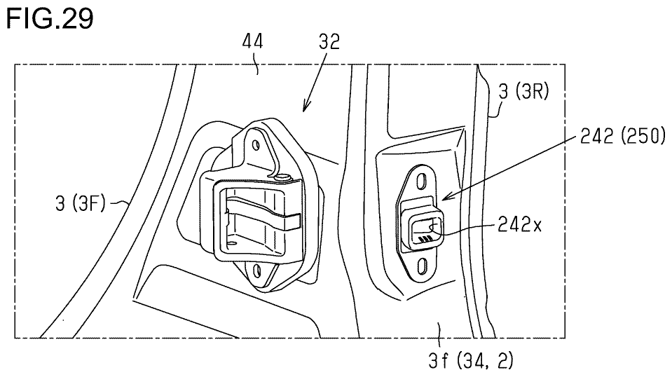

As illustrated in FIGS. 28 and 29, the door device 20 of the present embodiment includes a door side mating part 241 provided at the closing side end 33 of the door 5 and a vehicle body side mating part 242 provided at the closing side end 34 of the door opening 3. Furthermore, in the door device 20 of the present embodiment, these door side mating part 241 and vehicle body side mating part 242 mate with each other according to the full closing movement of the door 5. The door device 20 of the present embodiment is thus configured to stably support the door 5 placed at the fully open position P1 by the down stopper 250 formed by these door side mating part 241 and vehicle body side mating part 242.

In detail, in the vehicle 1 of the present embodiment, the door side mating part 241 is placed at the front end 5f of the door 5, which is the closing side end 33 of the door 5, near the above-described door side engagement part 31. The vehicle body side mating part 242 is placed at the front edge 3f of the door opening 3, which is the closing side end 34 of the door opening 3, near the above-described vehicle body side engagement part 32. Furthermore, in the door device of the present embodiment, the door side mating part 241 has a projecting mating protrusion 241x, and the vehicle body side mating part 242 has a mating recess 242x. The down stopper 250 of the present embodiment is thus configured to secure a stable holding force of the door 5 placed at the fully-closed position P0 by the mating of these mating protrusion 241x of the door side mating part 241 and the mating recess 242x of the vehicle body side mating part 242.

### Action of the Present Embodiment

That is, by setting a groove width change section α with a narrow groove width W1, the roller 185 of the engagement member 180 placed in the cam groove 170 is easily engaged in a state of contacting the side wall surface 170s of the cam groove 170 in this groove width change section α. As a result, the posture stabilizing effect of the door 5 can be easily obtained by the engagement between the engagement member 180 provided in the variable link 100 and the cam groove 170 of the cam member 160 provided in the door 5.

### Effects of the Present Embodiment

Next, the effects of the present embodiment are described.
(1) The door device 20 includes an engagement member 180 provided in a variable link 100 equipped with a variable connection length mechanism 50, and a cam member 160 provided on a door 5 having a cam groove 170 with which the engagement member 180 engages. Furthermore, the extension end 172e of the cam groove 170 that comes into close proximity to the engagement part 180x of the engagement member 180 that has moved within the cam groove 170 according to the full opening movement of the door 5 is the opening side end 170b of the cam groove 170. The cam groove 170 has a groove width change section α that is set on the opening side of the extension region including the opening side end 170b, and the groove width W1 of the cam groove 170 in this groove width change section α is narrower than the groove width W0 on the closing side of the extension region than the groove width change section α.

According to the above-described configuration, the door 5 supported by the link mechanism 15 that is constituted of the variable link 100 having the variable connection length mechanism 50 can suppress the sway and vibration of the door 5 more effectively.

(2) The variable link 100 has a configuration as an articulated link 110 that rotatably connects a vehicle body side link 101 having a first rotational connection point X1 and a door side link 102 having a second rotational connection point X2.

That is, by using the articulated link 110, the connection length L between the first and second rotational connection points X1, X2 can be changed according to the relative rotation of the vehicle body side link 101 and the door side link 102. Furthermore, the articulated link 110, according to the folded shape, can ensure a high degree of freedom in designing the opening and closing movement posture of the door 5, although the door 5 supported by this articulated link 110 is prone to sway and vibration. Thus, a more remarkable effect can be obtained by applying the embodiment to the configuration of using such an articulated link 110 as the variable link 100.

(3) The door device 20 includes a rotation regulating part 150 that regulates the relative rotation of the door side link 102 with respect to the door 5 around the second rotational connection point X2 by contacting the door side link 102 that has rotated around the second rotational connection point X2 according to the opening movement of the door 5. Further, a straight line passing through the intermediate connection point X3 between the vehicle body side link 101 and the door side link 102 and the second rotational connection point X2 is defined as a reference line M. Furthermore, when the vehicle body side link 101 rotates around the intermediate connection point X3 beyond this reference line M, the position where the roller 185 constituting the engagement part 180x of the engagement member 180 provided in the vehicle body side link 101 engages with the cam groove 170 is defined as a reference position Q. Then, the groove width change section α is provided on the opening side of the extension region in the cam groove 170 than this reference position Q.

That is, rotation of the door side link 102 is regulated around the second rotational connection point X2 by contacting the stopper part 148 as the rotation regulating part 150 such that the vehicle body side link 101 apparently rotates relative to the door 5 around the intermediate connection point X3. At this time, the reaction force generated by the roller 185 of the engagement member 180 pressed against the side wall surface 170s of the cam groove 170 is transmitted to the door side link 102 via the vehicle body side link 101. Furthermore, when the roller 185 in the cam groove 170 is positioned on the opening side of the extension region than the above-described reference position Q, the reaction force of the roller 185 acts in a direction of pressing the door side link 102 against the stopper part 148 at the contact point X0 with the stopper part 148. Then, by allowing elastic deformation of the stopper part 148 against which this door side link 102 is pressed, the reaction force generated by the roller 185 of the engagement member 180 pressed against the side wall surface 170s of the cam groove 170 is mitigated. Thus, according to the above-described configuration, the roller 185 of the engagement member 180 located in the groove width change section α can smoothly move within the groove width change section α in a state where the roller 185 is pressed against the side wall surface 170s of the cam groove 170. This allows the door 5 supported by the variable link 100 configured as the articulated link 110 to open and close smoothly, while securing the posture stabilizing effect of the door 5 by setting the groove width change section α where the groove width W1 is narrow.

(4) The door device 20 includes a door stopper 220 that uses the first link arm 11 as a contact link 210 to contact the first link arm 11 at the fully closed position P0 of the door 5, thereby regulating the relative rotation of the first link arm 11 and the door 5. In addition, the door device 20 includes a door stopper 200 that uses the second link arm 12 as a contact link 210 to contact the second link arm 12 at the fully closed position P0 of the door 5, thereby regulating the relative rotation of the second link arm 12 and the door 5.

According to the above-described configuration, the door 5 supported by the link mechanism 15 constituted of the first and second link arms 11, 12 can be stably supported at the fully open position P1.

(5) The door device 20 has the first link arm 11 as the first contact link 211 and the door stopper 220 to be in contact with this first link arm 11 as the first door stopper 231. The door device 20 also has the second link arm 12 as the second contact link 212 and the door stopper 200 to be in contact with this second link arm 12 as the second door stopper 232. The door device 20 is thus configured such that when the second contact link 212 and the door 5 rotate relative to each other in a state where the first contact link 211 is in contact with the first door stopper 231, the second door stopper 232 becomes in contact with the second contact link 212.

According to the above-described configuration, a constant support posture by the link mechanism 15 at the fully open position P1 of the door 5 can be ensured by prioritizing the contact of the first contact link 211 and the first door stopper 231. Furthermore, both the first door stopper 231 and the second door stopper 232 contact the corresponding first contact link 211 and second contact link 212, respectively, and, at the same time, can regulate their relative rotation to the door 5. This allows the door 5 to be more stably supported at the fully open position P1.

(6) The cam groove 170 includes a gradual change section β in which the groove width W gradually narrows toward the opening side of the extension region.

According to the above-described configuration, the roller 185 of the engagement member 180 that moves within the cam groove 170 according to the opening movement of the door 5, can smoothly enter the extension region where the groove width W is set narrower.

The above-described embodiment can be implemented with the following modifications. The above-described embodiment and the following modifications can be implemented in combination with each other to the extent that they are technically consistent.

In the above-described embodiment, the second link arm 12 was described as a variable link 100 having a variable connection length mechanism 50. However, without limitation, the embodiment may be applied to a configuration in which the first link arm 11 is the variable link 100 having the variable connection length mechanism 50. Alternatively, the embodiment may be applied to a configuration in which both the first and second link arms 11, 12 are variable links 100.

In the above-described embodiment, the variable link 100 was described as an articulated link 110 that rotatably connects a vehicle body side link 101 having a first rotational connection point X1 and a door side link 102 having a second rotational connection point X2. However, the configuration of the variable link 100 may be arbitrarily changed without limitation as long as the variable link 100 has a function of the variable connection length mechanism 50. For example, the embodiment may be applied to a configuration in which the variable link 100 is formed using a telescopic link that enables the connection length L between the first and second rotational connection points X1, X2 to be changed by the relative displacement of the first and second link members in the axial direction.

The configuration of the articulated link 110 may be arbitrarily changed even in a case where the articulated link 110 is used as the variable link 100. For example, the shapes of the vehicle body side link 101 and door side link 102 that constitute the articulated link 110 may be arbitrarily changed. The placement of the vehicle body side link 101 and door side link 102, including the positional relationship between the intermediate connection point X3 between the vehicle body side link 101 and door side link 102 and the second rotational connection point X2 with respect to the door 5, may also be changed arbitrarily.

In the above-described embodiment, a tensile coil spring 145 is used as an energizing member 140 to apply a rotational force to the door side link 102 around the second rotational connection point. However, the configuration of the energizing member 140 may be changed arbitrarily without limitation. For example, a torsion spring, a compression spring, or the like may be used to apply a rotational force to the door side link 102. Instead of the spring member, the configuration may also use an energizing member of gas type, electromagnetic type, or other types. The placement of the energizing member 140 may also be changed arbitrarily.

Furthermore, the embodiment does not necessarily have an energizing member 140. For example, the embodiment may be applied to a configuration in which a motor, a solenoid, or the like is used as a drive source to change the connection length L between the first and second rotational connection points X1, X2 by relative rotation of the vehicle body side link 101 and the door side link 102.

In the above-described embodiment, the lower wall 122b of the door bracket 122 constitutes a cam member 160 with a cam groove 170 on the door 5 side. However, without limitation, the upper wall 122a of the door bracket 122 may be configured to function as the cam member 160. Then, the cam member 160 may be configured to be provided separately from the door bracket 122.

In the above-described embodiment, the cam groove 170 of the cam member 160 has a first groove section 171 having an abbreviated linear groove shape and a second groove section 172 having an abbreviated arcuate groove shape. Furthermore, these first groove section 171 and second groove section 172 form an extension region extending in the opening width direction of the door opening 3. The extension end 172e of the second groove section 172 located on the opening side of this extension region is the opening side end 170b of the cam groove 170, and the engagement part 180x of the engagement member 180 that has moved within the cam groove 170 comes into close proximity to the opening side end 170b according to the full opening movement of the door 5.

However, without limitation, the groove shape of the cam groove 170 may be changed arbitrarily according to the configuration of the variable link 100 provided with the engagement member 180 placed in this cam groove 170, as well as, the opening and closing movement trajectory R of the door 5 according to the movement of the variable connection length mechanism 50.

Furthermore, the groove width W of the cam groove 170 may also be set arbitrarily. That is, the dimensions of these groove widths W1, W0 are arbitrary as long as the groove width W1 of the cam groove 170 in the groove width change section α that is set on the opening side of the extension region is narrower than the groove width W0 on the closing side of the extension region than the groove width change section α.

The position of the groove width change section α in the extension region of the cam groove 170 is also arbitrary. However, it is preferable that the engagement part 180x of the engagement member 180 placed in the cam groove 170 can smoothly move within the groove width change section α in a state where the engagement part 180x is pressed against the sidewall surface 170s of the cam groove 170 due to the narrow groove width W1 set in that groove width change section α.

Furthermore, the engagement member 180 on the variable link 100 side that engages with the cam groove 170 may also be changed arbitrarily in its shape. For example, the engagement part 180x that engages with the cam groove 170 does not necessarily be a roller 185.

In the above-described embodiment, the cam groove 170 has a gradual change section β in which the groove width W gradually narrows toward the opening side of the extension region. This gradual change section β is provided in a boundary region adjacent to the groove width change section α. However, without limitation, the gradual change section β may be within the groove width change section α. That is, the groove width W1 in the groove width change section α does not necessarily be constant as long as the groove width W1 is narrower than the groove width W0 on the closing side of the extension region than the groove width change section α.

For example, a gradual change section β may be provided near the opening side end 170b of the cam groove 170. By adopting such a configuration, the posture stabilizing effect of the door 5 by setting a groove width W1 narrower in the groove width change section α can be enhanced. This allows the door 5 to be supported more stably at the fully open position P1.

The cam groove 170 may instead be configured without the gradual change section β.

In the above-described embodiment, a door stopper 220 that uses the first link arm 11 as the contact link 210 and a door stopper 200 that uses the second link arm 12 as the contact link 210 are provided. At the fully closed position P0 of the door 5, these door stoppers 220, 200 are in contact with the first and second link arms 11, 12 respectively as the contact links 210 to regulate their relative rotation to the door 5. However, without limitation, either one of the door stopper 220 that uses the first link arm 11 as the contact link 210 or the door stopper 200 that uses the second link arm 12 as the contact link 210 may be configured to be provided.

Also, in the above-described embodiment, the first link arm 11 and the door stopper 220 are the first contact link 211 and the first door stopper 231, and the second link arm 12 and the door stopper 200 are the second contact link 212 and the second door stopper 232. Then, when the second contact link 212 and the door 5 are rotated relative to each other in a state where the first contact link 211 is in contact with the first door stopper 231, the second door stopper 232 becomes in contact with the second contact link 212.

However, without limitation, the second link arm 12 and the door stopper 200 may be the first contact link 211 and first door stopper 231, and the first link arm 11 and the door stopper 220 may be the second contact link 212 and the second door stopper 232. Then, the first contact link 211 and the second contact link 212 may be configured to contact the first door stopper 231 and second door stopper 232, respectively, at approximately the same timing according to the full opening movement of the door 5.

The door stoppers 200, 220 as described above may also be applied to a configuration where neither the first or second link arm 11, 12 is variable links 100, or a configuration where neither of them has the cam mechanism 190 formed by the above-described cam groove 170 and engagement member 180.

In the above-described embodiment, the first link arm 11 configured as a main link 21 is placed above the second link arm 12 configured as a sub link 22. The second link arm 12 is placed closer to the closing side end 33 of the door 5 than the first link arm 11 is. However, without limitation, the placement of these first and second link arms 11, 12 may be changed arbitrarily.

In the above-described embodiment, the first link arm 11 is configured as a drive link 55, and a drive device 51 rotationally drives this first link arm 11. However, without limitation, the second link arm 12 may be used as the drive link 55. Furthermore, both the first and second link arms 11, 12 may be configured as the drive link 55. Then, the number and placement of the drive device 51 may also be changed arbitrarily.

The above-described embodiment is applied to a configuration in which the door 5 of the vehicle 1 opens toward the rear of the vehicle, but the embodiment may be applied to a configuration in which the door 5 opens toward the front of the vehicle. In addition, the embodiment may be applied to a manual type door device for vehicle that does not have a drive device 51.

In the above-described embodiment, the door side engagement part 31 has an axial engagement part 41, and the vehicle body side engagement part 32 has a guide groove 42. However, without limitation, the door side engagement part 31 may be configured to have a guide groove 42 and the vehicle body side engagement part 32 may be configured to have an axial engagement part 41. Although the axial engagement part 41 is formed by a roller 41x that is rotatable around a support shaft, the axial engagement part 41 does not necessarily rotate. Further, the axial engagement part 41 does not necessarily have an axial shape as long as the axial engagement part 41 has a shape that functions as a guide engagement part that guides the opening and closing movement of the door 5 in a state where it is placed in the guide groove 42.

The number and placement of the door side engagement part 31 and vehicle body side engagement part 32 may be changed arbitrarily. Then, the embodiment may be applied to a configuration without such a door side engagement part 31 or vehicle body side engagement part 32.

### <Supplementary Notes>

The following describes a technical concept that can be grasped from the above-described embodiment and modified examples.
(a) The variable link is an articulated link that rotatably connects a vehicle body side link having a first rotational connection point and a door side link having a second rotational connection point.

That is, by using the articulated link, the connection length between the first and second rotational connection points can be changed according to the relative rotation of the vehicle body side link and the door side link. Furthermore, the articulated link can ensure a high degree of freedom in designing the opening and closing movement posture of the door according to the folded shape, while the door supported by the articulated link is prone to sway and vibration. Therefore, a more remarkable effect can be obtained by applying the embodiment to the configuration of using such an articulated link as the variable link.

(b) A rotation regulating part is provided that regulates relative rotation of the door side link to the door around the second rotational connection point by contacting the door side link that has rotated around the second rotational connection point according to the door opening movement. The groove width change section is provided on the opening side of the extension region in the cam groove than the reference position where the engagement part of the engagement member provided in the vehicle body side link engages with the cam groove when the vehicle body side link rotates around the intermediate connection point between the vehicle body side link and the door side link beyond the reference line passing through the intermediate connection point and the second rotational connection point.

That is, the rotation of the door side link around the second rotational connection point is regulated by contacting the rotation regulating part such that the vehicle body side link apparently rotates relative to the door around the intermediate connection point. At this time, the reaction force generated by the engagement part of the engagement member pressed against the side wall surface of the cam groove is transmitted to the door side link via the vehicle body side link. Furthermore, when the engagement part in the cam groove is located on the opening side of the extension region than the reference position, the reaction force of this engagement part acts in a direction of pressing the door side link against this rotation regulating part at the contact point against the rotation regulating part. Then, by allowing elastic deformation of the rotation regulating part against which the door side link is pressed, the reaction force generated by the engagement part of the engagement member pressed against the side wall surface of the cam groove is mitigated. Therefore, according to the above-described configuration, the engagement part of the engagement member located in the groove width change section can smoothly move within the groove width change section in a state where the engagement part is pressed against the side wall surface of the cam groove. This allows the door, supported by the variable link configured as the articulated link, to open and close smoothly, while securing the posture stabilizing effect of the door by setting the groove width change section with a narrow groove width.

(c) At least one of the first and second link arms is a contact link, and a door stopper is provided that regulates the relative rotation of the contact link and the door by contacting the contact link at the fully open position of the door.

According to the above-described configuration, the door supported by the link mechanism constituted of the first and second link arms can be stably supported at the fully open position.

(d) A first door stopper contacting a first contact link by using one of the first and second link arms as the first contact link and a second door stopper contacting a second contact link by using the other one of the first and second link arms as the second contact link, are provided. When the second contact link and the door are rotated relative to each other in a state where the first contact link is in contact with the first door stopper, the second contact link becomes in contact with the second door stopper.

According to the above-described configuration, by prioritizing the contact of the first contact link and the first door stopper, a constant support posture can be secured by the link mechanism at the fully open position of the door. Furthermore, both the first door stopper and the second door stopper contact their corresponding first contact link and second contact link, respectively, and, at the same time, can regulate their relative rotation to the door 5. This allows the door to be more stably supported at the fully open position.

(e) The cam groove includes a gradual change section where the groove width gradually narrows toward the opening side of the extension region.

According to the above-described configuration, the contacting part of the engagement member that moves within the cam groove according to the opening movement of the door can smoothly enter the extension region where the groove width is set narrower.

A door device for vehicle according to the present disclosure includes a first link arm and a second link arm each having a first rotational connection point with respect to a vehicle body and a second rotational connection point with respect to a vehicle door, the door opens and closes, based on movement of a link mechanism constituted of the first link arm and second link arm, at least one of the first link arm and the second link arm is a variable link with a variable connection length mechanism that allows a connection length between the first rotational connection point and the second rotational connection point to be changed, the door device for vehicle includes: an engagement member being provided in the variable link; and a cam member being provided on the door and having a cam groove with which the engagement member engages, an extension end of the cam groove that comes into close proximity to an engagement part of the engagement member that moves within the cam groove, based on full opening movement of the door, is an opening side end of the cam groove, the cam groove has a groove width change section being set on an opening side of an extension region including the opening side end, and a groove width of the cam groove in the groove width change section is narrower than a groove width of the cam groove on a closing side of the extension region than the groove width change section.

According to the above-described configuration, sway and vibration can be more effectively suppressed for a door supported by a link mechanism configured to use a variable link with a variable connection length mechanism.

According to the present disclosure, the door can be stably supported.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door device for vehicle comprising a first link arm and a second link arm each having a first rotational connection point with respect to a vehicle body and a second rotational connection point with respect to a vehicle door, wherein the door opens and closes, based on movement of a link mechanism constituted of the first link arm and second link arm, and at least one of the first link arm and the second link arm is a variable link with a variable connection length mechanism that allows a connection length between the first rotational connection point and the second rotational connection point to be changed, the door device for vehicle comprising:
an engagement member being provided in the variable link; and
a cam member being provided on the door and having a cam groove with which the engagement member engages, wherein
an extension end of the cam groove that comes into close proximity to an engagement part of the engagement member that moves within the cam groove, based on full opening movement of the door is an opening side end of the cam groove, and
the cam groove has a groove width change section being set on an opening side of an extension region including the opening side end, and a groove width of the cam groove in the groove width change section is narrower than a groove width of the cam groove on a closing side of the extension region than the groove width change section.

2. The door device for vehicle according to claim 1, wherein the variable link is an articulated link that rotatably connects a vehicle body side link having the first rotational connection point and a door side link having the second rotational connection point.

3. The door device for vehicle according to claim 2 further comprising
a rotation regulating part that regulates relative rotation of the door side link with respect to the door around the second rotational connection point by contacting the door side link that rotates around the second rotational connection point, based on opening movement of the door, wherein the groove width change section is provided closer on the opening side of the extension region in the cam groove than a reference position where the engagement part of the engagement member provided in the vehicle body side link engages with the cam groove when the vehicle body side link rotates around an intermediate connection point between the vehicle body side link and the door side link beyond a reference line passing through the intermediate connection point and the second rotational connection point.

4. The door device for vehicle according to claim 1, wherein at least one of the first link arm and the second link arm is defined as a contact link, and the door device further comprises a door stopper that regulates relative rotation of the contact link and the door by contacting the contact link at a fully open position of the door.

5. The door device for vehicle according to claim 2, wherein at least one of the first link arm and the second link arm is defined as a contact link, and the door device further comprises a door stopper that regulates relative rotation of the contact link and the door by contacting the contact link at a fully open position of the door.

6. The door device for vehicle according to claim 3, wherein at least one of the first link arm and the second link arm is defined as a contact link, and the door device further comprises a door stopper that regulates relative rotation of the contact link and the door by contacting the contact link at a fully open position of the door.
